(19) United States
(12) Patent Application Publication
(10) Pub. No.: US 2023/0151211 A1
(43) Pub. Date: May 18, 2023

(54) Polymer Blends Having Improved Ion Conductivity, Devices, and Methods

(71) Applicants: The Florida State University Research Foundation, Inc., Tallahassee, FL (US); The Trustees of the University of Pennsylvania, Philadelphia, PA (US)

(72) Inventors: Daniel Hallinan, Jr., Tallahassee, FL (US); Justin G. Kennemur, Tallahassee, FL (US); Karen I. Winey, Philadelphia, PA (US); Benjamin A. Paren, Philadelphia, PA (US); Kyoungmin Kim, Sandy, UT (US); Michael Patrick Blatt, Tallahassee, FL (US)

(21) Appl. No.: 18/056,562

(22) Filed: Nov. 17, 2022

Related U.S. Application Data
(60) Provisional application No. 63/280,382, filed on Nov. 17, 2021.

(51) Int. Cl. C08L 71/02; H01M 10/0525; H01M 10/0565

(52) U.S. Cl. CPC C08L 71/02; H01M 10/0525; H01M 10/0565; H01M 2300/0082

(57) ABSTRACT

Polymer blends that may be used as electrolytes. Devices that include polymer blends. Methods of forming polymer blends. The polymer blends may include a polysolvent and a polymer, such as a polymer that includes a negatively charged sidechain. The devices may include a lithium ion battery.

### CROSS-REFERENCE TO RELATED APPLICATIONS

This application claims priority to U.S. Provisional Patent Application No. 63/280,382, filed Nov. 17, 2021, which is incorporated herein by reference.

### STATEMENT REGARDING FEDERALLY SPONSORED RESEARCH OR DEVELOPMENT

This invention was made with government support under Contract Nos. 1545884, 1904767, and 1804871 awarded by the National Science Foundation (NSF). The government has certain rights in this invention.

### BACKGROUND

The market for batteries, such as lithium-ion batteries, continues to grow significantly, likely due to increasing demand for electric vehicles and utility scale storage for renewable energy.

As concerns about the global impact of man-made emissions continue to increase, energy dense battery storage is paramount to facilitate the effective utilization of clean energy sources. Currently, lithium-ion batteries are among the most employed technologies due to their high specific energies and steady state current densities.

However, lithium-ion battery failures stemming from thermal runaway, electrolyte flammability, and mechanical damage to the separator are serious safety impediments to the scale up of lithium-ion systems. Each of these issues typically stems from a central problem, which is the reactive nature of the aprotic organic carbonate solvents employed in the lithium-ion electrolytes. Furthermore, poor chemical stability against alkali metals can prevent the use of the most energy dense metals as electrodes, particularly lithium metal.

Lithium metal is a highly sought after anode as it has the highest specific capacity of any electrode, 3860 mAh/g, and the lowest potential of any metal of −3.04 V vs. the standard hydrogen electrode (SHE) (see, e.g., He, Y. et al. Journal of Materials Chemistry A 2020, 8 (5), 2518-2528). This high capacity and voltage could be instrumental in the scale up of battery technologies to meet the demands of modern power systems.

Polymer electrolyte batteries offer a possible way to circumvent some of these issues and facilitate the use of lithium by replacing reactive liquid electrolytes with more stable solid polymer electrolyte (SPE) (see, e.g., Beers, K. M. et al. Macromolecules 2011, 44 (22), 8866-8870; Hallinan, D. T. et al. Journal of the Electrochemical Society 2013, 160 (3), A464-A470; and Hallinan, D. T. et al. MRS Bulletin 2018, 43 (10), 759-767).

Study of SPEs has focused on aliphatic polyethers with dissolved small molecular weight salts. In particular, the poly(ethylene oxide) (PEO) and lithium bis(trifluoromethane-sulfonyl) imide (LiTFSI) electrolyte system has been studied most rigorously due to its long unparalleled ionic conductivity among SPEs. The maximum conductivity of PEO doped with LiTFSI is on the order of 10⁻³ S/cm at 90° C. Conversely, liquid electrolytes typically have conductivities on the order of 10⁻²-10⁻¹ S/cm at room temperature (see, e.g., Hallinan, D. T. et al. MRS Bulletin 2018, 43 (10), 759-767; Hallinan, D. T., Jr. et al. Annual Review of Materials Research, Vol 43, Clarke, D. R., Ed. 2013; Vol. 43, p. 503; and Peng, B. et al. Polymer 2013, 54 (21), 5779-5789).

As such, even the most competitive binary SPE lag several orders of magnitude behind the conductivity of their conventional liquid electrolyte counterparts, thus inhibiting the wide use of SPE.

Beyond these transport limitations, the adoption of lithium metal electrodes has been delayed by the potential for uneven growth of the solid electrolyte interface (SEI) resulting in the formation of dendrite shorts. Dendrite growth results from surface irregularities and cracks along the lithium electrode that permit increased surface area for lithium-ion transport. Dendrite growth is promoted by concentration gradients across the cell inherent in binary electrolytes. Dendrites lead to reductions in columbic efficiency, and the eventual failure of the electrochemical cell.

A possible solution to these problems is the single ion conductor (SIC). SICs are electrolytes in which only one ion, typically the cation, is mobile during battery cycling. The restricted mobility of the anion is achieved by covalently bonding the anion directly on the polymer backbone through modification of an existing polymer or direct polymerization of functionalized monomers.

Single ion conductors can offer a few principal advantages. First, these electrolytes have cation transference numbers (t₊⁰) approaching unity, meaning most of the charge is carried by the positive ions. As a point of comparison, binary SPE typically have t₊⁰ values less than 0.5.

As a result, SICs do not become polarized during cycling as anion mobility is restricted. More precisely, because polarization is inversely proportional to the cation transference number, as t₊⁰→1 concentration gradients across the electrolyte approach zero. As such, in a perfect single ion conductor (t₊⁰=1), concentration overpotential is completely avoided, leading to better battery efficiency and decreased internal resistance. Furthermore, it has been shown that the steady state current density of single ion conductors is typically equivalent to binary electrolytes with conductivities an order of magnitude greater than the single ion conductor. Lastly, single ion conductors have been shown to suppress dendrite growth when compared to their binary counterparts. While this phenomenon is most extensively studied with the copper electrode, studies suggest that the initial formation of dendrites, as represented by the Sand's time, is inversely related to the cation transference number. Thus, by raising the transference, single ion conductors have the potential to overcome many of the transport limitations and failure mechanisms of binary SPE.

Recent studies have focused on polymer blend electrolytes in which one blend component, the polysolvent, acts to facilitate lithium dissociation and transport while the other component, the polyanion, has anions covalently bound to the polymer backbone. In most cases, poly(ethylene oxide) is used as the polysolvent while the polyanion features large, charge delocalized anions. The utility of PEO as a polysolvent can largely be attributed to its ether oxygen which facilitates lithium dissociation from the counteranions, and promotes chain flexibility, a crucial property in allowing cation transport via segmental motion. Similarly, large, delocalized anion groups can permit self-dissociation of the cation/anion complex as charge is spread across many atoms in the cation. The use of blends offers modularity in the ion to solvent ratio, as well as the molecular weight of each component, drastically reducing synthesis time. This movement has featured studies on a wide variety of anion groups and sizes. As time has progressed, anion groups have generally increased in size while ionic conductivities have increased accordingly. Polymer blend electrolytes can be competitive with PEO/LiTFSI blends.

There remains a need for improved polymer blends, including polymer blends that may be used as or in electrolytes, such as electrolytes that are a safer alternative to other polymer- or liquid-based electrolytes. There also remains a need for polymer blends that exhibit conductivities that are comparable to liquid electrolytes.

### BRIEF SUMMARY

Provided herein are compositions, which may be used as an electrolyte in devices, such as lithium-ion batteries. In some embodiments, polymer blends are provided, including a blend of poly(ethylene oxide) with precise phenylated polyethylene functionalized with lithium (trifluoromethanesulfonyl)imide. As described herein, the polymer blends may be used as or in membranes for single-ion conduction for potential use in energy storage and/or battery applications. Embodiments of the polymer blends provided herein are single-ion conductors. Single-ion conductors may lead to higher transference numbers compared to conventional salt-in-polymer electrolytes. In some embodiments, the compositions and polymer blends are solvent free, which may make the polymer blends safer to handle/use than those that includes a flammable solvent (alone or with a polymer) as an electrolyte. The compositions provided herein may have a number of applications.

In one aspect, compositions are provided. In some embodiments, the compositions include a polymer blend. The polymer blend may include a polysolvent and a polymer including a repeat unit according to Formula (A):

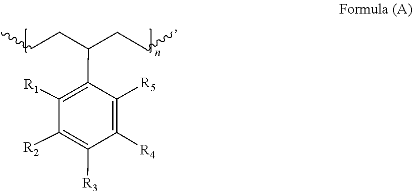

wherein R₁-R₅ are independently selected from (i) hydrogen, (ii) a substituent of formula (a), or (iii) a monovalent C₁-C₁₀ hydrocarbyl; wherein at least one of R₁-R₅ is the substituent of formula (a);

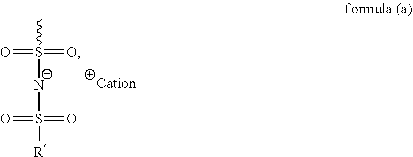

wherein R′ is a halogenated C₁-C₅ hydrocarbyl; and wherein n is 1 to 10,000. The polysolvent and the polymer including the repeat unit according to formula (A) may be present at any amount.

In another aspect, devices are provided herein. The devices may include any of the compositions described herein, including a composition in the form of a film or other shape. The devices may include batteries, such as lithium-ion batteries.

In yet another aspect, methods of forming compositions are provided. In some embodiments, the methods include dissolving a polysolvent and a polymer including the repeat unit according to formula (A) in a solvent to form a mixture; and removing at least a portion of the solvent form the polymer blend.

Additional aspects will be set forth in part in the description which follows, and in part will be obvious from the description, or may be learned by practice of the aspects described herein. The advantages described herein may be realized and attained by means of the elements and combinations particularly pointed out in the appended claims. It is to be understood that both the foregoing general description and the following detailed description are exemplary and explanatory only and are not restrictive.

### BRIEF SUMMARY OF THE DRAWINGS

FIG. 1 depicts an embodiment of a device disclosed herein.

FIG. 2A depicts differential scanning calorimetry thermograms of various materials, including embodiments of polymer blends.

FIG. 2B depicts the T_{g} of various materials.

FIG. 3 depicts X-ray scattering data collected from embodiments of polymer blends.

FIG. 4 depicts dᵢ and dₐₘₒᵣₚₕ of an embodiment of a polymer blend as a function of temperature.

FIG. 5A depicts the ionic conductivities of embodiments of polymer blends as a function of temperature.

FIG. 5B depicts the T_{g}-normalized ionic conductivity of embodiments of polymer blends.

FIG. 6A depicts a plot of ε′ for an embodiment of a polymer blend.

FIG. 6B depicts a plot of ε″ for an embodiment of a polymer blend.

FIG. 7A depicts τ_{α} and τ_{α2} vss inverse temperature for embodiments of polymer blends.

FIG. 7B depicts a plot of dielectric constant versus temperature for embodiments of polymer blends.

FIG. 8 depicts a double-logarithmic plot of the molar conductivity, A, versus the PEO relaxation time for embodiments of the polymer blends.

FIG. 9 depicts differential scanning thermograms of embodiments of polymer blends.

FIG. 10 depicts the T_{g} of embodiments of polymer blends as a function of weight fraction of an embodiment of a polysolvent.

FIG. 11A depicts second heading differential scanning thermograms of embodiments of polymer blends.

FIG. 11B depicts cooling differential scanning thermograms of an embodiment of a polysolvent after equilibration with various weight percentages of an embodiment of a polyanion.

FIG. 11C depicts the melting temperatures of an embodiment of a polysolvent as a function of the weight fraction of an embodiment of a polyanion.

FIG. 11D depicts the degrees of crystallinity per mass of an embodiment of a polysolvent as a function of the weight fraction of an embodiment of a polyanion.

FIG. 12 depicts crystallization temperatures of embodiments of polymer blends.

FIG. 13A depicts the ionic conductivities of embodiments of polymer blends vs. temperature.

FIG. 13B depicts the ionic conductivities of embodiments of polymer blends vs. the weight fraction of an embodiment of a polymer.

FIG. 14 depicts the cation transference number of various embodiments of polymer blends.

FIG. 15 depicts an Arrhenius plot of lithium-ion conductivity for embodiments of compositions described herein.

### DETAILED DESCRIPTION

Provided herein are compositions that include polymer blends, which may be used as or in electrolytes. Embodiments of the compositions may overcome one or more of the foregoing disadvantages.

### Compositions

In one aspect, compositions are provided that include a polymer blend. The polymer blend may include a polysolvent and a polymer, wherein the polymer includes a repeat unit according to formula (A), as described herein.

As used herein, the phrase “polymer blend” refers to a mixture of a polysolvent and a polymer, such as a polymer that includes a repeat unit according to formula (A). When a polymer is the minor component of a polymer blend, the polymer may be distributed (for example, substantially evenly distributed) in the polysolvent. When a polysolvent is the minor component of a polymer blend, the polysolvent may be distributed (for example, substantially evenly distributed) in the polymer.

In some embodiments, the composition is a miscible polymer blend. As used herein, the phrase “miscible polymer blend” refers to a polymer blend that has a single-phase structure, and exhibits one glass transition temperature.

Generally, any weight ratio of a polysolvent and a polymer may be present in the compositions or polymer blends described herein. In some embodiments, a weight ratio of the polysolvent to the polymer in the compositions or the polymer blends described herein is about 1:99 to about 99:1, about 10:90 to about 90:10, about 20:80 to about 80:20, about 30:70 to about 70:30, about 40:60 to about 60:40, about 45:55 to about 55:45, or about 50:50.

The compositions described herein may consist of a polysolvent and a polymer including the repeat unit of formula (A). The compositions described herein may comprise a polysolvent and a polymer including the repeat unit of formula (A). In some embodiments, the polysolvent and the polymer, in total, are present in the composition at an amount of at least 90%, at least 95%, or at least 99%, by weight, based on the total weight of the composition. A composition may include residual solvent or one or more additives, such as an additive that improves one or more properties of the compositions, such as a physical property (e.g., flexibility), electrical conductivity, etc.

The compositions described herein generally may be in any form, e.g., a monolithic shape, particles, etc. In some embodiments, the composition is in the form of a film, a block, or other object having a three-dimensional shape. When the composition is in the form of a film, the film may have a thickness of about 1 micrometer to about 1 mm, about 1 micrometer to about 500 micrometers, about 50 micrometers to about 200 micrometers, or 100 micrometers to about 200 micrometers.

### Polymers

In some embodiments, the polymer includes a repeat unit of formula (A):

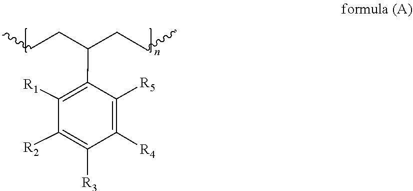

wherein R₁-R₅ are independently selected from (i) hydrogen, (ii) a substituent of formula (a), or (iii) a monovalent C₁-C₁₀ hydrocarbyl; wherein at least one of R₁-R₅ is the substituent of formula (a);

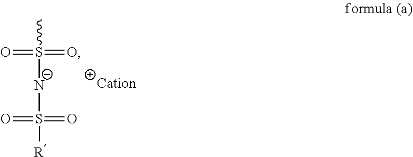

wherein R′ is a halogenated C₁-C₅ hydrocarbyl; and wherein n is 1 to 10,000.

As used herein, the phrase “halogenated C₁-C₅ hydrocarbyl” refers to a hydrocarbyl that includes 1 to 5 carbon atoms, and at least one halogen substituent.

In some embodiments, R₃ is the substituent of formula (a), and R₁, R₂, R₄, and R₅ are hydrogen.

In some embodiments, R′ of formula (a) is a perhalogenated C₁-C₅ hydrocarbyl, such as a perfluorinated C₁-C₅ hydrocarbyl. In some embodiments, R′ is a trifluoromethyl, and the substituent of formula (a) has the following structure:

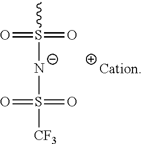

The polymer generally may have any degree of substitution of the substituent of formula (a). In some embodiments, the polymer including the repeat unit according to formula (A) has a degree of substitution of the substituent of formula (a) of about 1% to about 125%, about 25% to about 125%, about 50% to about 125%, about 75% to about 125%, about 80% to about 120%, or about 80% to about 100%.

In some embodiments, the polymer that includes the repeat unit according to formula (A) is at least partially cross-linked. The cross-linking may be achieved via olefins in a polymer's “backbone”. Therefore, as used herein, the symbol “ [symbol] ” at the terminal positions of a monomer may represent one bond in polymers that are not cross-linked, or one or two bonds in polymers that are cross-linked. For example, when the polymers are not cross-linked, the symbol “ [symbol] ” may represent one bond between the carbon atom of the monomer and [1] an atom of an adjacent monomer of the polymer chain, or [2] an end group; and when the polymers are cross-linked, the symbol “ [symbol] ” may represent one or two bonds, such as (i) one bond between the carbon atom of the monomer and an atom of a monomer of a different polymer chain, or (ii) a first bond between the carbon atom of the monomer and [1] an atom of an adjacent monomer of the polymer chain or [2] an end group, and a second bond between the carbon atom of the monomer and [1] an atom of a non-adjacent monomer of the polymer chain or [2] an atom of a monomer of a different polymer chain. The terms “monomer” and “repeat unit” are used interchangeably herein.

In some embodiments, n is about 10 to 1,000,000, about 10 to about 500,000, about 10 to about 100,000, about 10 to about 50,000, about 10 to about 25,000, about 10 to about 9,000, about 10 to about 8,000, about 10 to about 7,000, about 10 to about 6,000, about 10 to about 5,000, about 10 to about 4,000, about 10 to about 3,000, about 50 to about 3,000, about 50 to about 2,000, about 50 to about 1,000, or about 50 to about 500.

In some embodiments, the polymer including the repeat unit according to formula (A) includes a structure according to formula (B):

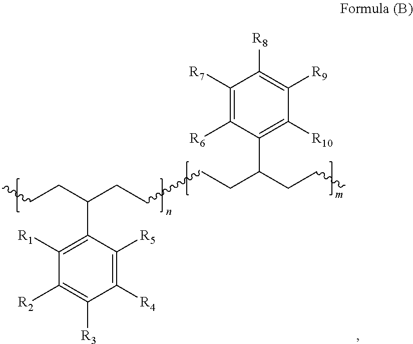

wherein R₁-R₁₀ are independently selected from (i) hydrogen, (ii) a substituent of formula (a), (iii) a substituent of formula (b), or (iv) a monovalent C₁-C₁₀ hydrocarbyl;

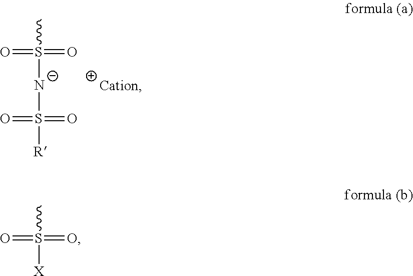

wherein R′ is a halogenated C₁-C₅ hydrocarbyl, and X is a halogen; wherein at least one of R₁-R₅ is the substituent of formula (a), and wherein n and m independently are 1 to 10,000.

In some embodiments, at least one of R₁-R₅ differs from at least one of R₆-R₁₀ in the polymers of formula (B). Therefore, the term “polymer”, as used herein, refers to and includes homopolymers, copolymers (e.g., block copolymers), oligomers, etc. of any configuration, including, but not limited to, crosslinked, star, comb, etc.

In some embodiments, the degree of substitution of (i) the substituent of formula (a), (ii) the substituent of formula (b), or (iii) the substituent of formula (a) and the substituent of formula (b), in total, of the polymers described herein is about 1% to about 150%, about 1% to about 125%, about 1 to about 100%, about 75% to about 125%, or about 80% to about 120%. The phrase “in total” indicates that when a polymer includes both the substituent of formula (a) and the substituent of formula (b), the sum of the degree of substitution of the substituent of formula (a) and the degree of substituent of the substituent of formula (b) satisfies one of the foregoing ranges, e.g., “about 1% to about 150%.”

As used herein, the “degree of substitution of the substituent of formula (a) [or formula (b)]”, which is provided as a percentage herein, generally indicates the average number of substituents of formula (a) [or formula (b)] per phenyl pendant group of the polymers provided herein. For example, a degree of substitution of 100% indicates an average of one substituent of formula (a) [or formula (b)] per phenyl pendant group. Degrees of substitution less than 100% indicate an average of less than one substituent of formula (a) [or formula (b)] per phenyl pendant group, and degrees of substitution greater than 100% indicate an average of more than one substituent of formula (a) [or formula (b)] per phenyl pendant group, thereby indicating that a least a portion of the phenyl pendant groups should be substituted with more than one substituent of formula (a) [or formula (b)]. For example, a degree of substitution of 80% indicates that an average of 80 out of every 100 phenyl pendant groups are substituted with one substituent of formula (a) [or formula (b)].

In some embodiments, the sum of “m” and “n” of formula (B) is about 200 to about 1,200, about 300 to about 1,075, about 500 to about 1,075, about 500 to about 1,000, about 500 to about 800, or about 600 to about 700. Generally, the polymers of formula (B) herein may include any ratio of “m” to “n” in order to achieve a desired degree of substitution. For example, R₃ may be a substituent of formula (a); R₁, R₂, and R₄-R₁₀ may be hydrogen; and the ratio of n:m may be 80:20, thereby imparting the polymer with a degree of substitution of 80%.

In some embodiments, the polymer including the repeat unit of formula (A) includes one or more end groups, such as one or more end groups derived from ethyl vinyl ether, end groups derived from telechelic chain transfer agents, or a combination thereof.

The substituent of formula (a) of the polymers described herein may include any cation. In some embodiments, the cation of the substituent of formula (a) is an inorganic cation. The inorganic cation may include an alkali metal, such as lithium.

### Polysolvents

The compositions described herein may include any polysolvent, including a polysolvent that facilitates a desirable conductivity. In some embodiments, the polysolvent is a polymer having a glass transition temperature (T_{g}) of −40° C. or less, −45° C. or less, −50° C. or less, −55° C. or less, or −60° C. or less.

In some embodiments, the polysolvent includes at least one atom or functional group that (i) facilitates dissociation of the cation of the substituent of formula (a) from the counteranion of the substituent of formula (a), (ii) increases chain flexibility, or (iii) a combination thereof. The at least one atom or functional group may include an ether moiety. In some embodiments, the polysolvent includes a high shear modulus block copolymer.

In some embodiments, the polysolvent includes a poly(alkylene oxide). In some embodiments, the poly(alkyelene oxide) includes poly(ethylene oxide) (PEO).

In some embodiments, the polysolvent has a number average molecular weight (Mₙ) of about 1,000 g/mol to about 30,000 g/mol, about 1,000 g/mol to about 25,000 g/mol, about 5,000 g/mol to about 25,000 g/mol, about 10,000 g/mol to about 25,000 g/mol, about 15,000 g/mol to about 25,000 g/mol, about 18,000 g/mol to about 22,000 g/mol, or about 20,000 g/mol. In some embodiments, the polysolvent has a number average molecular weight (Mₙ) of about 100 g/mol to about 2,000 g/mol, about 500 g/mol to about 2,000 g/mol, about 500 g/mol to about 1,500 g/mol, about 800 g/mol to about 1,200 g/mol, or about 1,000 g/mol.

### Devices

In another aspect, devices are provided herein. The devices may include any of the compositions described herein. In some embodiments, the device is an energy storing device or a power producing device. The device may be a battery, such as a lithium-ion battery.

In some embodiments, the device is a battery, such as a lithium-ion battery, and includes a first current collector, an anode, a cathode, and a second current collector. Any of the compositions described herein may be arranged between the anode and the cathode. The anode may be arranged between any of the compositions described herein and the first current collector. In some embodiments, the cathode is arranged between any of the compositions described herein and the second current collector.

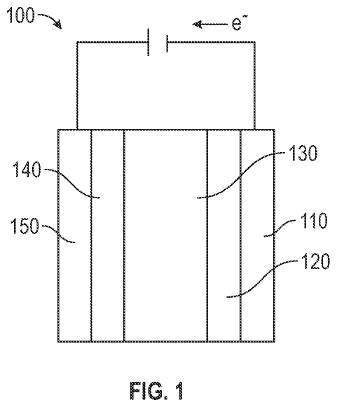

An embodiment of a battery is depicted at FIG. 1. FIG. 1 depicts a battery 100 that includes a first current collector 110, an anode 120, an electrolyte 130, a cathode 140, and a second current collector 150. The electrolyte 130 may include a composition as described herein, such as a composition in the form of a film or a multi-layer film. In the electrolyte 130, the cation of the substituent of formula (a) may be lithium.

### Methods

Also provided herein are methods of forming compositions. In some embodiments, the methods include dissolving a polysolvent and a polymer including the repeat unit according to formula (A) in a solvent to form a mixture; and removing at least a portion of the solvent from the polymer blend.

A weight ratio of the poly solvent to the polymer including the repeat unit according to formula (A) in the solvent is about 1:99 to about 99:1, about 10:90 to about 90:10, about 20:80 to about 80:20, about 30:70 to about 70:30, about 40:60 to about 60:40, about 45:55 to about 55:45, or about 50:50.

Any fluid capable of dissolving the polymer and polysolvent may be used in the methods described herein. In some embodiments, the solvent includes water, an organic liquid, or a combination thereof. In some embodiments, the solvent includes water, a polar organic liquid, or a combination thereof. The polar organic liquid may be acetonitrile. The removing of at least a portion of the solvent may be achieved using any known technique. For example, drop casting may be used, which may include disposing a mixture on a heated surface for a time effective to evaporate the at least a portion of the solvent.

When used herein with regard to the selection of a substituent, the term “independently” indicates that (i) a substituent at a particular location may be the same or different for each molecule or monomer of a formula (e.g., a polymer may include two repeat units of formula (A), with each repeat unit having the same or a different C₁-C₁₀ hydrocarbyl selected for R¹), and/or (ii) two differently labeled substituents selected from the same pool of substituents may be the same or different (e.g., R¹ and R² of a monomer may both be selected from “a C₁-C₁₀ hydrocarbyl”, and the C₁-C₁₀ hydrocarbyls selected for R¹ and R² may be the same or different).

The phrases “C₁-C₁₀ hydrocarbyl,” “C₁-C₅ hydrocarbyl”, and the like, as used herein, generally refer to aliphatic, aryl, or arylalkyl groups containing 1 to 10, or 1 to 5 carbon atoms, respectively. Examples of aliphatic groups, in each instance, include, but are not limited to, an alkyl group, a cycloalkyl group, an alkenyl group, a cycloalkenyl group, an alkynyl group, an alkadienyl group, a cyclic group, and the like, and includes all substituted, unsubstituted, branched, and linear analogs or derivatives thereof, in each instance having 1 to about 20 carbon atoms. Examples of alkyl groups include, but are not limited to, methyl, ethyl, propyl, isopropyl, n-butyl, t-butyl, isobutyl, pentyl, hexyl, isohexyl, heptyl, 4,4-dimethylpentyl, octyl, 2,2,4-trimethylpentyl, nonyl, decyl, undecyl and dodecyl. Cycloalkyl moieties may be monocyclic or multicyclic, and examples include cyclopropyl, cyclobutyl, cyclopentyl, cyclohexyl, and adamantyl. Additional examples of alkyl moieties have linear, branched and/or cyclic portions (e.g., 1-ethyl-4-methyl-cyclohexyl). Representative alkenyl moieties include vinyl, allyl, 1-butenyl, 2-butenyl, isobutylenyl, 1-pentenyl, 2-pentenyl, 3-methyl-1-butenyl, 2-methyl-2-butenyl, 2,3-dimethyl-2-butenyl, 1-hexenyl, 2-hexenyl, 3-hexenyl, 1-heptenyl, 2-heptenyl, 3-heptenyl, 1-octenyl, 2-octenyl, 3-octenyl, 1-nonenyl, 2-nonenyl, 3-nonenyl, 1-decenyl, 2-decenyl and 3-decenyl. Representative alkynyl moieties include acetylenyl, propynyl, 1-butynyl, 2-butynyl, 1-pentynyl, 2-pentynyl, 3-methyl-1-butynyl, 4-pentynyl, 1-hexynyl, 2-hexynyl, 5-hexynyl, 1-heptynyl, 2-heptynyl, 6-heptynyl, 1-octynyl, 2-octynyl, 7-octynyl, 1-nonynyl, 2-nonynyl, 8-nonynyl, 1-decynyl, 2-decynyl and 9-decynyl. Examples of aryl or arylalkyl moieties include, but are not limited to, anthracenyl, azulenyl, biphenyl, fluorenyl, indan, indenyl, naphthyl, phenanthrenyl, phenyl, 1,2,3,4-tetrahydro-naphthalene, tolyl, xylyl, mesityl, benzyl, and the like, including any heteroatom substituted derivative thereof.

Unless otherwise indicated, the term “substituted,” when used to describe a chemical structure or moiety, refers to a derivative of that structure or moiety wherein (i) a multi-valent non-carbon atom (e.g., oxygen, nitrogen, sulfur, phosphorus, etc.) is bonded to one or more carbon atoms of the chemical structure or moiety (e.g., a “substituted” C₄ hydrocarbyl may include, but is not limited to, diethyl ether moiety, a methyl propionate moiety, an N,N-dimethylacetamide moiety, a butoxy moiety, etc., and a “substituted” aryl C₁₂ hydrocarbyl may include, but is not limited to, an oxydibenzene moiety, a benzophenone moiety, etc.) or (ii) one or more of its hydrogen atoms (e.g., chlorobenzene may be characterized generally as an aryl C₆ hydrocarbyl “substituted” with a chlorine atom) is substituted with a chemical moiety or functional group such as alcohol, alkoxy, alkanoyloxy, alkoxycarbonyl, alkenyl, alkyl (e.g., methyl, ethyl, propyl, t-butyl), alkynyl, alkylcarbonyloxy (—OC(O)alkyl), amide (—C(O)NH-alkyl- or -alkylNHC(O)alkyl), tertiary amine (such as alkylamino, arylamino, arylalkylamino), aryl, aryloxy, azo, carbamoyl (—NHC(O)O-alkyl- or —OC(O)NH-alkyl), carbamyl (e.g., CONH₂, as well as CONH-alkyl, CONH-aryl, and CONH-arylalkyl), carboxyl, carboxylic acid, cyano, ester, ether (e.g., methoxy, ethoxy), halo, haloalkyl (e.g., —CCl₃, —CF₃, —C(CF₃)₃), heteroalkyl, isocyanate, isothiocyanate, nitrile, nitro, oxo, phosphodiester, sulfide, sulfonamido (e.g., SO₂NH₂), sulfone, sulfonyl (including alkylsulfonyl, arylsulfonyl and arylalkylsulfonyl), sulfoxide, thiol (e.g., sulfhydryl, thioether) or urea (—NHCONH-alkyl-).

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of various embodiments, applicants in no way disclaim these technical aspects, and it is contemplated that the present disclosure may encompass one or more of the conventional technical aspects discussed herein.

The present disclosure may address one or more of the problems and deficiencies of known methods and processes. However, it is contemplated that various embodiments may prove useful in addressing other problems and deficiencies in a number of technical areas. Therefore, the present disclosure should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

In the descriptions provided herein, the terms “includes,” “is,” “containing,” “having,” and “comprises” are used in an open-ended fashion, and thus should be interpreted to mean “including, but not limited to.” When devices, compositions, or methods are claimed or described in terms of “comprising” various steps or components, the devices, systems, or methods can also “consist essentially of” or “consist of” the various steps or components, unless stated otherwise.

The terms “a,” “an,” and “the” are intended to include plural alternatives, e.g., at least one. For instance, the disclosure of “a polysolvent”, “a polymer”, and the like, is meant to encompass one, or mixtures or combinations of more than one polysolvent, polymer, and the like, unless otherwise specified.

Various numerical ranges may be disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Moreover, all numerical end points of ranges disclosed herein are approximate. As a representative example, Applicant discloses, in some embodiments, that a polymer has a degree of substitution of the substituent of formula (a) of about 80% to about 120%. This range should be interpreted as encompassing about 80% and about 120%, and about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 100%, about 101%, about 102%, about 103%, about 104%, about 105%, about 106%, about 107%, about 108%, about 109%, about 110%, about 111%, about 112%, about 113%, about 114%, about 115%, about 116%, about 117%, about 118%, and about 119%, including any ranges and sub-ranges between any of these values.

As used herein, the term “about” means plus or minus 10% of the numerical value of the number with which it is being used.

### Embodiments

The following is a listing of non-limiting embodiments of the compositions, devices, and methods described herein.

Embodiment 1. A composition comprising a polysolvent and a polymer, wherein the polymer comprises a repeat unit according to formula (A).

Embodiment 2. The composition of Embodiment 1, wherein the composition is a polymer blend; for example, when the polymer is the minor component, the polymer may be distributed (for example, substantially evenly distributed) in the polysolvent, or when the polysolvent is the minor component, the polysolvent may be distributed (for example, substantially evenly distributed) in the polymer.

Embodiment 3. The composition of Embodiment 1 or 2, wherein the composition is a miscible polymer blend.

Embodiment 4. The composition of any one of Embodiments 1 to 3, wherein a weight ratio of the polysolvent to the polymer comprising the repeat unit according to formula (A) in the composition or the polymer blend is about 1:99 to about 99:1, about 10:90 to about 90:10, about 20:80 to about 80:20, about 30:70 to about 70:30, about 40:60 to about 60:40, about 45:55 to about 55:45, or about 50:50.

Embodiment 5. The composition of any one of Embodiments 1 to 4, wherein the polysolvent and the polymer, in total, are present in the composition at an amount of at least 90%, at least 95%, or at least 99%, by weight, based on the total weight of the composition.

Embodiment 6. The composition of any one of Embodiments 1 to 5, wherein the composition is in the form of a film, a block, or other object having a three-dimensional shape.

Embodiment 7. The composition of Embodiment 6, wherein the film has a thickness of about 1 micrometer to about 1 mm, about 1 micrometer to about 500 micrometers, about 50 micrometers to about 200 micrometers, or 100 micrometers to about 200 micrometers.

Embodiment 8. The composition of any one of Embodiments 1 to 7, wherein formula (A) of the polymer has the following structure:

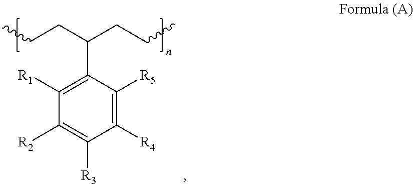

wherein R₁-R₅ are independently selected from (i) hydrogen, (ii) a substituent of formula (a), or (iii) a monovalent C₁-C₁₀ hydrocarbyl; wherein at least one of R₁-R₅ is the substituent of formula (a);

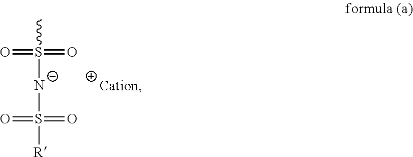

wherein R′ is a halogenated C₁-C₅ hydrocarbyl; and wherein n is 1 to 1,000,000.

Embodiment 9. The composition of Embodiment 8, wherein R₃ is the substituent of formula (a), and R₁, R₂, R₄, and R₅ are hydrogen.

Embodiment 10. The composition of Embodiment 8 or 9, wherein R′ is a perhalogenated C₁-C₅ hydrocarbyl, such as a perfluorinated C₁-C₅ hydrocarbyl.

Embodiment 11. The composition of any one of Embodiments 8 to 10, wherein R′ is a trifluoromethyl, and the substituent of formula (a) has the following structure:

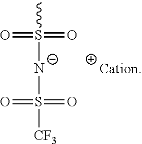

Embodiment 12. The composition of any one of Embodiments 8 to 11, wherein the polymer comprising the repeat unit according to Formula (A) has a degree of substitution of the substituent of formula (a) of about 1% to about 125%, about 25% to about 125%, about 50% to about 125%, about 75% to about 125%, about 80% to about 120%, or about 80% to about 100%.

Embodiment 13. The composition of any one of Embodiments 1 to 12, wherein the polymer comprising the repeat unit according to formula (A) is at least partially cross-linked.

Embodiment 14. The composition of any one of Embodiments 8 to 13, wherein n is 1 to about 500,000, 1 to about 250,000, 1 to about 100,000, about 10 to about 10,000, about 10 to about 9,000, about 10 to about 8,000, about 10 to about 7,000, about 10 to about 6,000, about 10 to about 5,000, about 10 to about 4,000, about 10 to about 3,000, about 50 to about 3,000, about 50 to about 2,000, about 50 to about 1,000, or about 50 to about 500.

Embodiment 15. The composition of any one of Embodiments 1 to 14, wherein the polymer comprising the repeat unit according to formula (A) comprises a structure according to Formula (B):

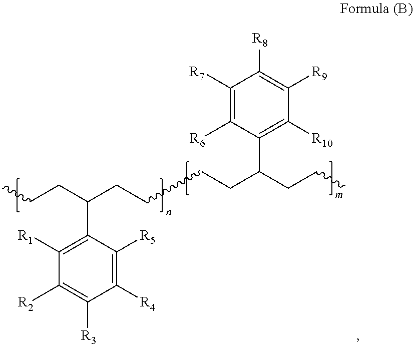

wherein R₁-R₁₀ are independently selected from (i) hydrogen, (ii) a substituent of formula (a), (iii) a substituent of formula (b), or (iv) a monovalent C₁-C₁₀ hydrocarbyl;

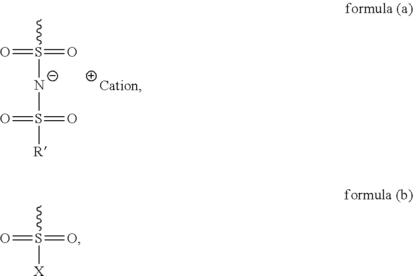

wherein R′ is a halogenated C₁-C₅ hydrocarbyl, and X is a halogen; wherein at least one of R₁-R₅ is the substituent of formula (a), and wherein n and m independently are 1 to 10,000.

Embodiment 16. The composition of Embodiment 15, wherein at least one of R₁-R₅ differs from at least one of R₆-R₁₀ in the polymers of formula (B).

Embodiment 17. The composition of Embodiment 15 or 16, wherein the degree of substitution of (i) the substituent of formula (a), (ii) the substituent of formula (b), or (iii) the substituent of formula (a) and the substituent of formula (b), in total, of the polymers is about 1% to about 150%, about 1% to about 125%, about 1 to about 100%, about 75% to about 125%, or about 80% to about 120%.

Embodiment 18. The composition of any one of Embodiments 15 to 17, wherein the sum of “m” and “n” of formula (B) is about 200 to about 1,200, about 300 to about 1,075, about 500 to about 1,075, about 500 to about 1,000, about 500 to about 800, or about 600 to about 700.

Embodiment 19. The composition of any one of Embodiments 1 to 18, wherein the polymer comprising the repeat unit of formula (A) includes one or more end groups, such as one or more end groups derived from ethyl vinyl ether, end groups derived from telechelic chain transfer agents, or a combination thereof.

Embodiment 20. The composition of any one of Embodiments 8 to 19, wherein the cation of the substituent of formula (a) is an inorganic cation.

Embodiment 21. The composition of Embodiment 20, wherein the inorganic cation comprises an alkali metal.

Embodiment 22. The composition of Embodiment 21, wherein the alkali metal comprises lithium.

Embodiment 23. The composition of any one of Embodiments 1 to 22, wherein the polymer comprising the repeat unit according to Formula (A) is a homopolymer.

Embodiment 24. The composition of any one of Embodiments 1 to 23, wherein the polysolvent comprises at least one atom or functional group that (i) facilitates dissociation of the cation of formula (a) from the counteranion of formula (a), (ii) increases chain flexibility, or (iii) a combination thereof.

Embodiment 25. The composition of Embodiment 24, wherein the at least one atom or functional group comprises an ether moiety.

Embodiment 26. The composition of any one of Embodiments 1 to 25, wherein the polysolvent has a glass transition temperature (T_{g}) of −40° C. or less, −45° C. or less, −50° C. or less, −55° C. or less, or −60° C. or less.

Embodiment 27. The composition of any one of Embodiments 1 to 26, wherein the polysolvent comprises a high shear modulus block copolymer.

Embodiment 28. The composition of any one of Embodiments 1 to 27, wherein the polysolvent comprises a poly(alkylene oxide).

Embodiment 29. The composition of Embodiment 28, wherein the poly(alkyelene oxide) comprises poly(ethylene oxide) (PEO).

Embodiment 30. The composition of any one of Embodiments 1 to 29, wherein the polysolvent has a number average molecular weight (Mₙ) of about 1,000 g/mol to about 30,000 g/mol, about 1,000 g/mol to about 25,000 g/mol, about 5,000 g/mol to about 25,000 g/mol, about 10,000 g/mol to about 25,000 g/mol, about 15,000 g/mol to about 25,000 g/mol, about 18,000 g/mol to about 22,000 g/mol, or about 20,000 g/mol.

Embodiment 31. The composition of any one of Embodiments 1 to 29, wherein the polysolvent has a number average molecular weight (Mₙ) of about 100 g/mol to about 2,000 g/mol, about 500 g/mol to about 2,000 g/mol, about 500 g/mol to about 1,500 g/mol, about 800 g/mol to about 1,200 g/mol, or about 1,000 g/mol.

Embodiment 32. A device comprising the composition of any one of Embodiments 1 to 31.

Embodiment 33. The device of Embodiment 32, wherein the device is an energy storage device and/or an energy producing device.

Embodiment 34. The device of Embodiment 33, wherein the device is a battery, such as a lithium-ion battery.

Embodiment 35. The device of Embodiment 34, wherein the lithium-ion battery further comprises a first current collector; an anode; a cathode; and a second current collector.

Embodiment 36. The device of Embodiment 35, wherein the composition of any one of Embodiments 1 to 31 is arranged between the anode and the cathode.

Embodiment 37. The device of Embodiment 35 or 36, wherein the anode is arranged between the composition of any one of Embodiments 1 to 31 and the first current collector.

Embodiment 38. The device of any one of Embodiments 35 to 37, wherein the cathode is arranged between the composition of any one of Embodiments 1 to 31 and the second current collector.

Embodiment 39. A method of forming a composition, such as a composition of any one of Embodiments 1 to 31, the method comprising dissolving a polysolvent (such as a polysolvent of any one of Embodiments 24-31) and a polymer comprising the repeat unit according to formula (A) (such as a polymer of any one of Embodiments 8 to 23) in a solvent to form a mixture; and removing at least a portion of the solvent from the polymer blend.

Embodiment 40. The method of Embodiment 39, wherein a weight ratio of the polysolvent to the polymer comprising the repeat unit according to formula (A) in the solvent is about about 1:99 to about 99:1, about 10:90 to about 90:10, about 20:80 to about 80:20, about 30:70 to about 70:30, about 40:60 to about 60:40, about 45:55 to about 55:45, or about 50:50. Embodiment 41. The method of Embodiment 39 or 40, wherein the solvent comprises water, a polar organic liquid, or a combination thereof.

Embodiment 42. The method of Embodiment 41, the polar organic liquid is acetonitrile. Embodiment 43. The method of any one of Embodiments 39 to 42, wherein the removing of at least a portion of the solvent comprises disposing the mixture on a heated surface for a time effective to evaporate the at least a portion of the solvent.

### EXAMPLES

The present invention is further illustrated by the following examples, which are not to be construed in any way as imposing limitations upon the scope thereof. On the contrary, it is to be clearly understood that resort may be had to various other aspects, embodiments, modifications, and equivalents thereof which, after reading the description herein, may suggest themselves to one of ordinary skill in the art without departing from the spirit of the present invention or the scope of the appended claims. Thus, other aspects of this invention will be apparent to those skilled in the art from consideration of the specification and practice of the invention disclosed herein.

### Example 1—Superionic Li-Ion Transport in a Single-Ion Conducting Polymer Blend Electrolyte

This example focuses on p5PhTFSI—Li as a starting material, a precise polyethylene with a LiTFSI-functionalized phenyl group spaced every five carbons along the backbone (see scheme below). The synthesis of p5PhTFSI—Li has been reported in the literature. In this example, p5PhTFSI—Li was blended with low-molecular-weight PEO (1000 g mol⁻¹)(Mₐ) and the nanoscale structure and polymer dynamics in combination with the ion transport properties were characterized. In blends with a ratio of ethylene oxide to Li+ (EO/Li) of 10, the system exhibited superionic transport well above the T_{g}, which is uncommon in single Li-ion conducting polymers.

Materials and Sample Preparation: p5PhTFSI—Li was made starting from poly(4-phenylcyclopentene) (P4PCP), which was produced through ring-opening metathesis polymerization (ROMP), and featured a precise linear polyethylene backbone with an atactic phenyl branch on every fifth carbon following mild hydrogenation of the olefins (p5Ph) (Neary, W. J. et al. Macromol. Rapid Commun. 2016, 37, 975-979). The synthesis of p5PhSA-Na was then performed, and the degree of sulfonation was 94%. (Kendrick, A. et al. Macromol. Rapid Commun. 2018, 39, 1800145; Neary, W. J. et al. Macromol. Rapid Commun. 2016, 37, 975-979).

The number average degree of polymerization (Nₙ) was 89, and the dispersity (D) was about 1.6. The synthesis of p5PhTFSI—Li from p5PhSA-Na, as performed in this example, is shown in the following scheme.

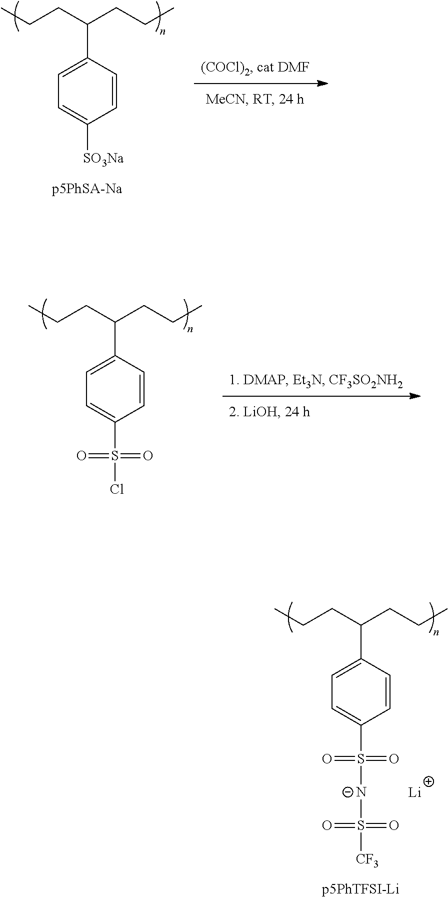

It was determined that 90% of the phenyl groups were successfully functionalized with a TFSI—Li moiety. In other words, the conversion efficiency from SA-Na to TFSI moieties was 96%.

Example 2 describes a detailed synthesis and characterization of these materials, including thermal gravimetric analysis (TGA), size exclusion chromatography (SEC), and multinuclear magnetic resonance (¹H, ¹³C, and ¹⁹F NMR).

PEO with a methyl ether at both ends and a number average molar mass (Mₙ) of about 1000 g mol⁻¹ (Nₙ=22) was obtained from Millipore Sigma (product no. 445894). Appropriate amounts of lyophilized p5PhTFSI—Li and as-received PEO were mixed to obtain the following ethylene oxide to Li⁺ (EO/Li) ratios: 0, 2, 5, and 10. These polymer mixtures were dissolved in deionized water (2-3 wt % polymer in solution) and stirred for at least 1 hour at 23±2° C.

Solutions were then drop cast onto 100 μm teflon at 80° C., and the solvent was evaporated to form polymer blend films. The as-cast polymer films were dried at high temperature under vacuum, as detailed below, before each of the following measurements were performed: differential scanning calorimetry (DSC), X-ray scattering, and dielectric relaxation spectroscopy (DRS).

Thermal Characterization. DSC was performed on the p5PhTFSI—Li blends and the neat PEO. The as-cast polymer films (4-10 mg) were dried at 180° C. for 1-2 days (EO/Li=0 and 2) and 120° C. for >12 h (EO/Li=5 and 10, and neat PEO) under vacuum, then immediately sealed in DSC pans for testing using a differential scanning calorimeter. Samples went through at least two cooling and heating cycles, at 10° C./min, with all samples heated to at least 150° C. and cooled to as low as −140° C. depending on the PEO content. The final heating was used to determine the T_{g} values and the melting point (neat PEO only).

X-ray Scattering. X-ray scattering measurements were performed at room temperature on the p5PhTFSI—Li blends and neat PEO. The as-cast polymer films (100-200 μm thick) were dried at 180° C. for 1-2 days (EO/Li=0 and 2) and at 120° C. for >12 h (EO/Li=5 and 10, and neat PEO) immediately before structural characterization.

The dual source and environmental X-ray scattering facility operated by the Laboratory for Research on the Structure of Matter at the University of Pennsylvania, with a Xeuss 2.0 system (Xenocs) and a GeniX3D Cu source (λ=1.54 Å), was used for X-ray scattering measurements. Sample-to-detector distances for X-ray scattering were 35 cm for small angles (SAXS) and 16 cm for wide angles (WAXS), covering a total q range of 0.05-2.0 Å⁻¹.

Samples were mounted on a mica window and measured for at least 1 h. The 2D X-ray scattering profiles were isotropic and thus were azimuthally integrated to 1D data using Foxtrot software after subtracting the mica window background. X-ray scattering peak positions were determined using the simultaneous fitting of scattering peaks with pseudo-Voigt functions. The neat PEO and EO/Li=10 samples were also measured at higher temperatures using a Linkam HFSX350-GI stage.

PEO was measured at 60° C. in order to obtain a scattering profile above its melting point. p5PhTFSI—Li EO/Li=10 was measured at select temperatures upon cooling from 130 to 30° C., keeping at each temperature for 1 h.

Dielectric Relaxation Spectroscopy. Ionic conductivity and dielectric relaxations were determined using DRS. The as-cast p5PhTFSI—Li blend films (50-100 μm thick) were sandwiched between two stainless steel electrodes, with silica spacers. The polymer-electrode assembly was placed into a cryostat and equilibrated under vacuum at 180° C. for 1-2 days (EO/Li=0 and 2) and at 120° C. for >12 h (EO/Li=5 and 10) to ensure any remaining water was removed and to maximize wetting of the polymer with the electrode interface. The measurements were performed using a Solartron Modulab XM materials test system in the frequency window 10-1-106 Hz under an applied voltage of 0.5 V. The polymers were measured every 5° C. upon cooling and held for 20 min at each temperature before measurement to let the polymer equilibrate.

In addition, polymers were measured upon heating to ensure reversibility. The polymers remained in a constant vacuum environment during the entirety of their equilibration and measurement. Temperature ranges varied per sample and included all of the temperatures at which a DC conductivity feature appeared in the frequency window of 10-1-106 Hz. The temperature ranges were 120-190° C. (EO/Li=0), 90-180° C. (EO/Li=2), 40-140° C. (EO/Li=5), and 30-130° C. (EO/Li=10). Impedance data (Z′ vs-Z″) were fit with an equivalent circuit model to determine the through-plane high-frequency resistance R, which is used to calculate the through-plane conductivity, σDC=L/AR, where L is the film thickness and A is the cross-sectional area (determined using ImageJ software area analysis). The permittivity spectra (ε′ and ε″) were also used to calculate conductivity and dielectric relaxation information as detailed below.

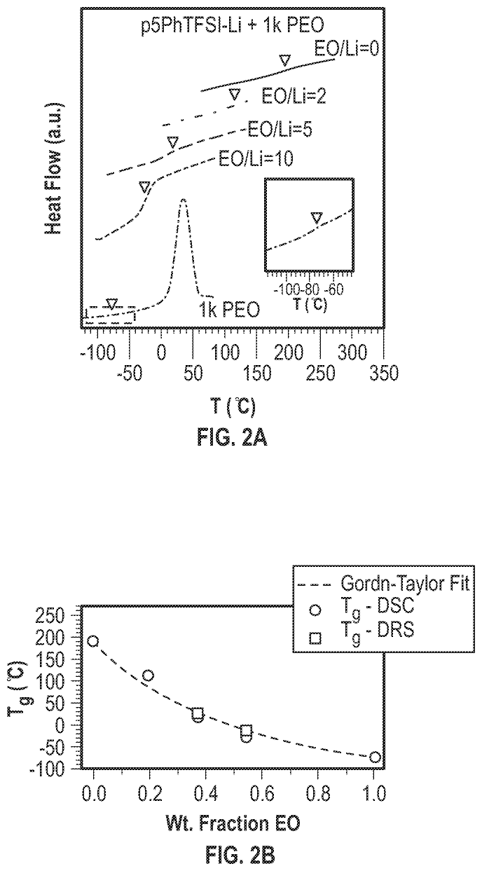

Thermal Properties of Blends. DSC was employed to investigate the T_{g} as well as PEO crystallinity in the blends of p5PhTFSI—Li and PEO, and was further corroborated with ionic conductivity and X-ray scattering results as explained below. DSC thermograms of the neat polymers and different blend compositions of PEO and p5PhTFSI—Li are shown at FIG. 2A.

FIG. 2A depicts DSC thermograms of heating of p5PhTFSI—Li, PEO, and their blends. Inverse triangles denote T_{g} values at the midpoint. FIG. 2B depicts a Corresponding T_{g} for different PEO contents and fitting with eq 1 (k=0.38). T_{g} values determined from DRS analysis of EO/Li=5 and 10 (detailed later) are also included.

An endothermic transition was observed in 1000 g mol⁻¹ PEO at 30° C. upon heating, and this was attributed to the melting of PEO crystallinity into an amorphous state. PEO had a crystallinity of 69% (Pielichowski, K. et al. Polym. Adv. Technol. 2003, 13, 690-696). PEO also exhibited a T_{g} of −75° C., which was consistent with PEO of low Mₙ. Neat p5PhTFSI—Li exhibited a single T_{g}, 199° C., which was higher than that of the parent p5Ph (T_{g}=17° C.) (Neary, W. J. et al. Macromol. Rapid Commun. 2016, 37, 975-979), likely as a result of bulkier side groups and interactions between ionic groups. This was lower than previously reported T_{g} for the polystyrene-based SIC, PSTFSI—Li (212-256° C.), likely due to the more flexible nature of the p5Ph backbone compared to PS and the lower overall ion content. (Liu, J. et al. Polym. Chem. 2020, 11, 461-471; Stacy, E. W. et al. Macromolecules 2018, 51, 8637-8645; and Cao, P. F. et al. Polymer (Guildf) 2017, 124, 117-127).

Upon addition of PEO into p5PhTFSI—Li, there was a significant reduction in T_{g}, and all blends exhibited only a single T_{g}, which indicated a miscible polymer blend. The absence of a melting peak in any of the blends also indicated a single-phase system, which suggested that ion transport in these blends was not be impeded by a crystalline PEO phase.

The T_{g} values fit well (FIG. 2B) with the Gordon-Taylor equation (Gordon, M. et al. J. Appl. Chem. 1952, 2, 493-500):

$${T}_{g} = \frac{{W}_{1} {T}_{g , 1} + k {W}_{2} {T}_{g , 2}}{{W}_{1} + k {W}_{2}} \qquad ( 1 )$$

where W₁ and W₂ are the weight fractions of each homopolymer component, PEO and p5PhTFSI—Li, respectively, and T_{g,1} and T_{g,2} are the T_{g} values of neat PEO and p5PhTFSI—Li, respectively. The parameter k accounts for the deviation from ideal mixing of binary mixtures and unequal contribution of each homopolymer component into the resulting T_{g}. For the p5PhTFSI—Li/PEO blends, a value of k=0.38 resulted in the best fitting of the Gordon-Taylor model and was similar to k reported for other single Li-ion conductors blended with PEO (Choi, U. H. et al. Macromolecules 2014, 47, 3145-3153; Olmedo-Martinez, J. L. et al. Macromolecules 2020, 53, 4442-4453).

While a single Tₜ indicated a singlephase material, k<1 suggested that the local dynamics were dominated by specific local interactions. In p5PhTFSI—Li blends, this was consistent with strong interactions between the TFSI—Li groups and the ether oxygen in PEO, and weaker interactions between the nonpolar p5Ph backbone and PEO.

The T_{g} values of the EO/Li=5 and 10 blends were also obtained from an analysis of segmental relaxation from the DRS measurements, as detailed in the following sections, with good agreement.

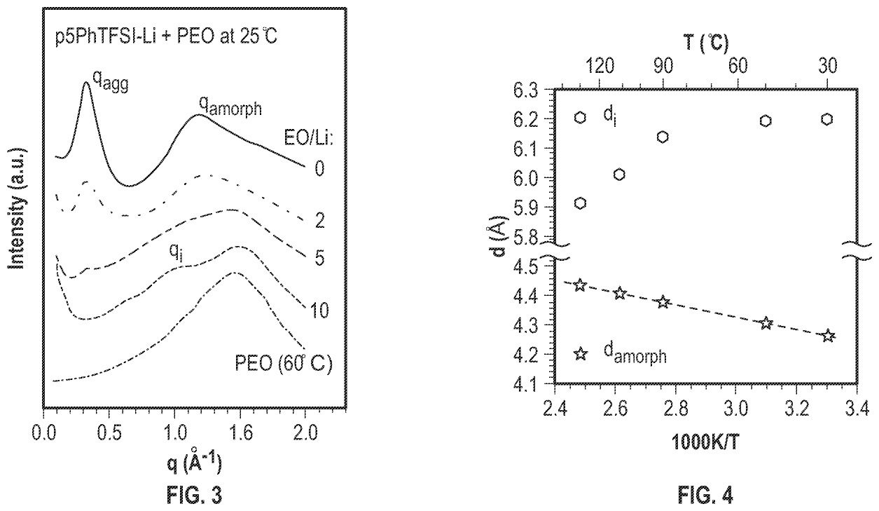

Nanoscale Morphology. X-ray scattering was performed on the p5PhTFSI—Li/PEO blends at 25° C. (FIG. 3), and all of the blends exhibited an asymmetric amorphous halo.

FIG. 3 depicts X-ray scattering data of neat p5PhTFSI—Li and blend compositions of p5PhTFSI—Li with PEO (Mₙ=1000 g mol⁻¹) at 25° C., shifted vertically for clarity. For comparison, the data were plotted against X-ray scattering data of neat PEO at 60° C. The X-ray profile of PEO at 25° C. was also collected.

For neat p5PhTFSI, the maximum of this amorphous halo was qₐₘₒᵣₚₕ˜1.2 Å⁻¹. This peak shifted toward the position of melt-state PEO in the EO/Li=10 blend, qₐₘₒᵣₚₕ˜1.4 Å⁻¹, which was comparable to that of the amorphous halo found in PEO at 60° C. The PEO (1000 g mol⁻¹) was semicrystalline at 25° C., showing multiple sharp peaks in the range q=1-2 Å⁻¹. The absence of crystalline peaks in FIG. 3 represented purely amorphous blends, indicating the miscibility between 1000 g mol⁻¹ PEO and p5PhTFSI—Li. If the polymers were phase-separated, it was likely that some of the PEO would crystallize, which was not evident in the room-temperature X-ray scattering or DSC results.

In addition to the amorphous halo, neat p5PhTFSI—Li exhibited q_{agg} at 0.33 Å⁻¹, which was associated with the characteristic length scale d_{agg}=19 Å of the ionic aggregates, where d=2π/q. In a previous study of p5PhSA-Li, which combined X-ray scattering and atomistic MD simulations, d_{agg} corresponded to the center-to-center spacing between distinct sections of a percolated aggregate. Thus, in this example, the low-angle peak found in the p5PhTFSI—Li and the blends was assigned to the ionic aggregates. This spacing was a primary factor determining the aggregate spacing (Paren, B. A. et al. Macromolecules 2020, 53, 8960-8973).

Upon addition of PEO to p5PhTFSI—Li, the intensity of the q_{agg} peak decreased while maintaining a similar position in the EO/Li=2 and 5 blends, with d_{agg}˜19 Å, and this aggregate peak disappeared in the EO/Li=10 blend. Previous studies of PEO-based copolymer ionomers have also demonstrated the disappearance of q_{agg}, which was attributed to the suppression of ionic aggregation by the addition of PEO (O'Reilly, M. et al. Polymer (Guildf) 2015, 59, 133-143; Zhang, Z. et al. Macromolecules 2017, 50, 963-971).

However, it was proposed that the weakening of qagg with increasing PEO content in the p5PhTFSI—Li/PEO blends was likely the result of a loss of scattering contrast between the polar and nonpolar phases. Estimates of the electron densities, based on the van der Waals volume (VDWV), 43 of p5Ph (˜504 nm⁻³) and amorphous PEO (˜488 nm⁻³) were very similar and both lower than that of TFSI—Li (835 nm⁻³), so the addition of PEO to the ionic domains reduced the electron density differences between the polar and nonpolar domains.

This phenomenon has been reported in computational and experimental studies of multiple sulfonated proton-conducting polymers swollen with water (Sorte, E. G. et al. Macromolecules 2019, 52, 857-876; Paren, B. A. et al. Chem. Mater. 2021, 33, 6041-6051).

In those studies, the presence of water lowered the electron density of the sulfonated polar domains, to values similar to that of the nonpolar backbone, leading to the disappearance of the aggregate peak, even though there was still nanophase separation.

A similar behavior was suspected in p5PhTFSI—Li and PEO blends, where 1000 g mol⁻¹ PEO interacted with the ions to swell the polar domains, decreasing the electron density of the ions and reducing the overall electron density contrast in the blends as a function of PEO content.

Schematics were prepared to depict the nanoscale morphology without and with PEO swelling the ionic assemblies and maintaining d_{agg}. The interaction of the PEO with the ions was further demonstrated at the high PEO contents of EO/Li=5 and EO/Li=10, with an additional peak, qᵢ, that appeared at ˜1 Å⁻¹, or di ˜6 Å. This peak corresponded to scattering from anion-anion correlations, and has been reported in studies of polymerized ionic liquids (Paren, B. A. Polym. Chem. 2019, 10, 2832-2839; Choi, U. H. et al. Macromolecules 2014, 47, 777-790; Liu, H. et al. ACS Macro Lett. 2016, 5, 537-543).

To explore the behavior of the qᵢ peak with temperature, one system was selected that exhibits this peak, EO/Li=10, and X-ray scattering was performed at select temperatures on cooling (130, 110, 90, and 50° C.). Overall, the scattering results were similar, which indicated continued blend miscibility.

FIG. 4 illustrates the change in dₐₘₒᵣₚₕ and dᵢ with temperature for the EO/Li=10 blend. FIG. 4 depicts dᵢ and dₐₘₒᵣₚₕ of the p5PhTFSI—Li/PEO EO/Li=10 blend as a function of temperature. The dashed line was a linear fit through dₐₘₒᵣₚₕ.

dₐₘₒᵣₚₕ decreased linearly as T−1 increased, which was consistent with thermal expansion of a polymer above the T_{g}. Conversely, dᵢ increased with T−1, which suggested that the ions were closer together at a higher temperature with dᵢ=5.9 at 130° C. Previously studied PEO-based sulfonate copolymers have shown aggregation to occur upon heating, a result of stronger columbic interactions between ions occurring at higher temperatures (Wang, W. et al. J. Am. Chem. Soc. 2011, 133, 10826-10831). In this example, the ions remain solvated by the PEO, and the reduced interion distance may similarly have been a result of stronger columbic interactions at higher temperatures.

While phase separation was not observed in these blends with 1000 g mol⁻¹ PEO, higher PEO concentrations could have induced macrophase separation. In Example 2, which describes the production and testing of p5PhTFSI—Li blended with 20,000 g mol⁻¹ PEO, at high PEO contents (>70 wt % PEO), there was evidence of macrophase separation. This suggested that as the PEO content was increased in these 1000 g mol₋₁ PEO blends, even before macrophase separation occurred, the LiTFSI functional groups may have started to expel excess PEO toward the center of the polar domains.

At a sufficiently high PEO content, this could lead to macrophase separation, as seen in the 20,000 g mol⁻¹ blends of Example 2.

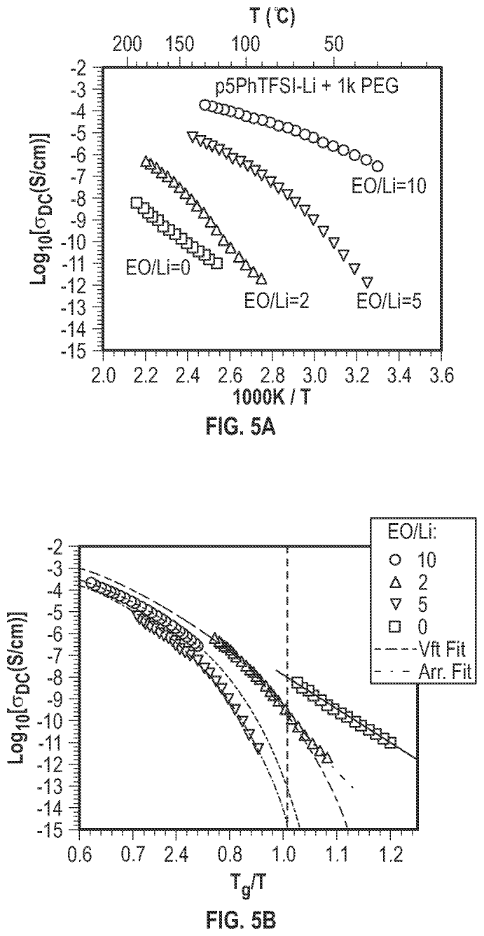

Ionic Conductivity. Ionic conductivity (σDC) of p5PhTFSI—Li with varying PEO contents was examined as a function of temperature, FIG. 5A.

FIG. 5A depicts ionic conductivity of neat p5PhTFSI—Li and blend compositions with PEO as a function of temperature. FIG. 5B depicts T_{g}-normalized ionic conductivity of neat p5PhTFSI—Li and different EO/Li concentrations along with VFT and Arrhenius fits of conductivity (eqs 2 and 3). Vertical dashed line represents T_{g}/T=1. The T_{g} for EO/Li=5 and 10 was the mean of T_{g}-DSC and T_{g}-DRS, and the T_{g} for EO/Li=0 and 2 was just T_{g}-DSC because T_{g} for these samples could not be determined from DRS measurements.

σDC was determined from the Nyquist plot by fitting to an equivalent circuit model, and was completely reversible for all of the blends studied upon heating and cooling. Neat p5PhTFSI—Li exhibited Arrhenius behavior and had an ionic conductivity from 10-11 S cm⁻¹ at 120° C. to 10⁻⁸ S cm⁻¹ at the highest measured temperature of 190° C.

$${σ}_{D C} = {σ}_{0} exp ( \frac{- {E}_{a}}{RT} ) \qquad ( 2 )$$

The activation energy of ˜130 kJ mol⁻¹ and values of conductivity were very similar to those of previously reported functionalized polystyrenes, PSTFSI—Li (Liu, J. et al. Polym. Chem. 2020, 11, 461-471; Stacy, E. W. et al. Macromolecules 2018, 51, 8637-8645; and Cao, P. F. et al. Polymer (Guildf) 2017, 124, 117-127). This was expected when the functional groups were the same, and decoupled ion transport occurred in a similar local environment.

As PEO was added to p5PhTFSI—Li, conductivity increased significantly, with EO/Li=10 exhibiting the fastest ion transport of all blends studied. The EO/Li=10 blend had a σDC of 3.8×10⁻⁵ S cm⁻¹ at 90° C. and 1.8×10⁻⁴ S cm⁻¹ at 130° C., which was 7 orders of magnitude greater than that of EO/Li=0 at the same temperature. The drastic increase in conductivity was likely largely due to the increase in polymer mobility in the amorphous blends from the low-T_{g} PEO. These conductivity values were consistent with those explained in Example 2 for p5PhTFSI—Li blended with 20,000 g mol₋₁ PEO. The EO/Li=10 conductivity values were also similar to those measured in PSTFSI—Li/PEO blends in the literature (Meziane, R. et al. Electrochim. Acta 2011, 57, 14-19; Ma, Q. et al. RSC Adv. 2016, 6, 32454-32461).

It should be noted that the p5PhTFSI—Li used here was synthesized using postpolymerization modification, as opposed to monomer synthesis for PSTFSI—Li, thereby demonstrating an alternative route to access this level of ion transport.

To improve polymer electrolyte design, it can be important to understand the mechanisms of ion transport that are present. σDC exhibits VFT-like behavior (FIG. 5B) in the EO/Li=5 and 10 blends at all temperatures tested (at T>>T_{g}), which indicated a dependence on segmental mobility in ion transport.

$${σ}_{D C} = {σ}_{∞} exp ( \frac{- B}{T - {T}_{0}} ) \qquad ( 3 )$$

For EO/Li=2, a VFT-to-Arrhenius transition in σDC occurred at approximately its T_{g} of 118° C. (FIG. 5B), as the dominant ion transport mechanism transitions between decoupled hopping and coupled with segmental relaxation. At T_{g}, the conductivity was highest for neat p5PhTFSI—Li, 10⁻⁸ S cm⁻¹, which was expected due to ionic aggregates that facilitated decoupled ion transport when the polymer was glassy. The conductivity at T_{g} was reduced with the addition of PEO. This was likely because transport of Li+ in PEO is typically dominated by the mobility of the PEO chains. Thus, when taken below T_{g}, Li+ surrounded by PEO likely becomes immobile compared to Li+ ions that are free to hop between neighboring TFSI⁻ groups.

When ion dynamics are completely coupled to segmental relaxations of the polymer, σDC should be in the order of 10⁻¹⁵ to 10⁻¹⁴ S cm⁻¹ at the T_{g} (Stacy, E. W. et al. Macromolecules 2018, 51, 8637-8645). This was likely the case for EO/Li=5, which has σDC˜10⁻¹⁵-10⁻¹⁴ S cm⁻¹ at T_{g}. However, the VFT fit of EO/Li=10 intersected with T_{g}/T=1 at 10⁻¹³ S cm⁻¹, which suggested that at least some amount of decoupled transport was taking place at and above the T_{g}.

Also explored were the segmental dynamics and decoupling of ion transport by analyzing the dielectric permittivity spectra.

Correlating Ion Transport with Segmental Dynamics. The real (ε′) and imaginary (ε″) components of the complex permittivity spectra ε*(w) were described by (Kremer, F. et al. Springer-Verlag: Berlin, 2002):

ε*(ω)=ε′−iε″ (4)

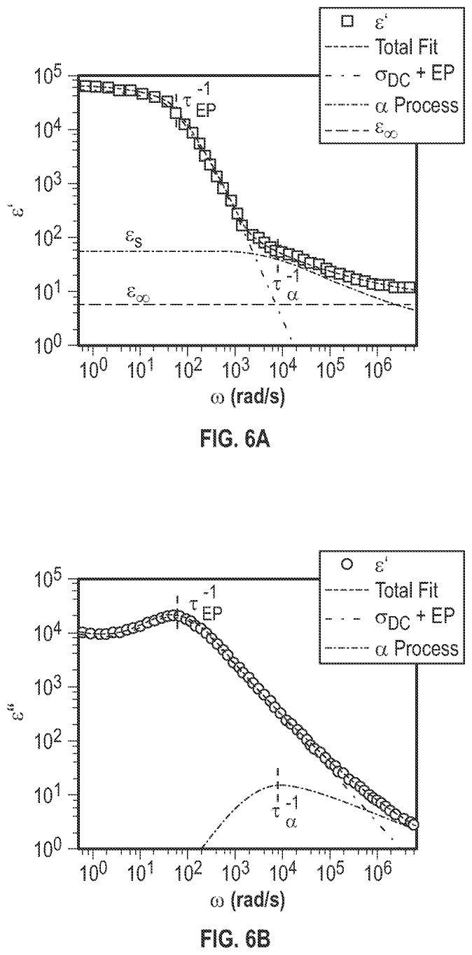

The complex permittivity was modeled (FIG. 6A and FIG. 6B) by the superposition of a Havriliak-Negami (HN) function and a term accounting for DC conductivity and electrode polarization (di Noto, V. et al. Electrochim. Acta 2011, 57, 192-200; di Noto, V. et al. J. Phys. Chem. B 2006, 110, 24972-24986; di Noto, V. J. Am. Chem. Soc. 2010, 132, 2183-2195):

$${ε}^{*} ( ω ) = {ε}_{∞} + \frac{{σ}_{D C}}{i ω} \frac{{( i ω {τ}_{EP} )}^{γ}}{[ 1 + {( i ω {τ}_{EP} )}^{γ} ]} + \frac{Δ {ε}_{α}}{[ 1 + ( i ω {τ}_{HN - α} \text{?} \text{?}} \\ \text{?} \text{indicates text missing or illegible when filed} \qquad ( 5 )$$

where ç_{∞} accounts for the permittivity at infinite frequency, the second term accounts for conductivity, σ_{DC}, and electrode polarization, where τ_{EP} is the relaxation time associated with electrode polarization, γ is the corresponding shape parameter for broadening of this relaxation, and the final term corresponds to a dielectric relaxation, either the _{α} or _{α2} process, where Δεα/α2 is the strength of the relaxation (Δεα/α2=εs−ε_{∞}), τHN-α is the HN relaxation time, and a and b are the shape parameters corresponding to symmetric and asymmetric broadening of the relaxation, respectively, where 0<a≤1 and 0<ab≤1. Equation 5 fit well to the experimental data, as demonstrated in FIG. 6A and FIG. 6B.

It should be noted that the σ_{DC} values obtained by fitting with eq 5 resulted in the same values as from previous fitting to the equivalent circuit model, as expected. These parameters were used to compute the relaxation times, τ_{α} and τ_{α2} with (Fan, F. et al. Macromolecules 2015, 48, 4461-4470; Tudryn, G. J. Macromolecules 2012, 45, 3962-3973).

$${τ}_{α / {α}_{2}} = {{τ}_{HN - α / {α}_{2}} ( sin \frac{a π}{2 + 2 b} )}^{- 1 / α} {( sin \frac{ab π}{2 + 2 b} )}^{1 / α} \qquad ( 6 )$$

The τ_{α} process corresponded to segmental relaxation of PEO coordinated with LiTFSI, and τ_{α2} to the rearrangement of ions. τ_{α} and τ_{α2} were distinguished by fitting to the relaxation time form of the VFT equation:

$${τ}_{α} = {τ}_{∞} exp ( \frac{B}{T - {T}_{θ}} ) \qquad ( 7 )$$

In polymers, it is generally accepted that the glass transition occurs when the segmental relaxation time τ_{α} is ˜100-1000 s (Fan, F. et al. Macromolecules 2015, 48, 4461-4470; Tudryn, G. J. et al. Macromolecules 2012, 45, 3962-3973; Fan, F. et al. Macromolecules 2013, 46, 9380-9389).

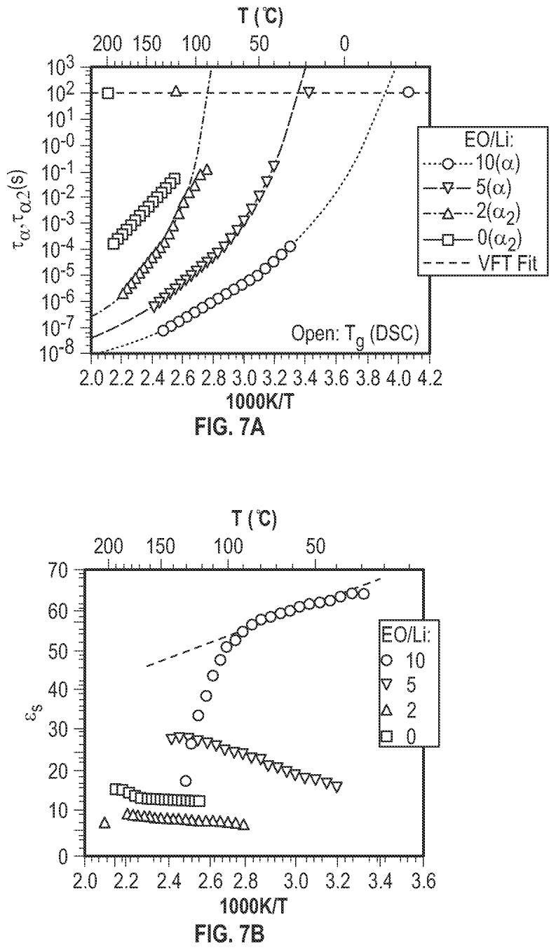

In FIG. 7A, the T_{g} from DRS is the temperature at which the VFT-fit of τ_{α}=100 s. The T_{g} values from DSC and DRS experiments were within 10° C. for both the EO/Li=5 and EO/Li=10 blends (T_{g}-DSC/T_{g}-DRS is 19° C./25° C. for EO/Li=5, and −27° C./−18° C. for EO/Li=10); these magnitudes of difference are commonly reported for polymer electrolytes (Choi, U. H. et al. Macromolecules 2014, 47, 3145-3153). This agreement in T_{g} suggested that the relaxation process in EO/Li=5 and 10 was predominantly segmental relaxation and thus was labeled as the _{α} process, noting that ion rearrangement would also be involved in the relaxation (Yoshida, K. et al. Electrochim. Acta 2011, 57, 139-146).

In contrast, both the neat p5PhTFSI—Li and EO/Li=2 blend exhibited Arrhenius behavior well before the relaxation time reached 100 s, which indicated that these relaxations were primarily not a result of segmental relaxation, but rather due to a rearrangement of ions, which, therefore, was identified as the α₂ process.

The dielectric constants, εₛ, of the ionomer and blends are shown in FIG. 7B. In the blend of EO/Li=10, the high dielectric constant resulted from strong dissociation of ions in the blend. Dielectric constants of similar magnitude have been previously observed in polyether-ester-sulfonate copolymer ionomers and are likely due to ion rearrangement associated with segmental relaxation (Tudryn, G. J. et al. Macromolecules 2012, 45, 3962-3973; Fragiadakis, D. et al. J. Chem. Phys. 2009, 130, 063659).

The dielectric constant of EO/Li=10 was fit to the Onsager equation:

$$( \frac{( {ε}_{s} - {ε}_{∞} ) ( 2 {ε}_{s} + {ε}_{∞} )}{{{ε}_{s} ( {ε}_{∞} + 2 )}^{2}} ) = \frac{{v}_{pair} {m}_{pair}^{2}}{9 {ε}_{0} kT} \qquad ( 8 )$$

where vₚₐᵢᵣ and mₚₐᵢᵣ, are the number and strength of ionic dipoles and vₚₐᵢᵣmₚₐᵢᵣ² is the only fitting parameter, which was assumed to be temperature-independent. Below 100° C., εₛ exhibited an excellent fit to eq 8, which indicated that the EO/Li=10 blend (T_{g}=−27° C.) behaved as a simple polar liquid, which is common in ionomers above T_{g} (see, e.g., Wang, W. et al. J. Am. Chem. Soc. 2011, 133, 10826-10831).

At temperatures >100° C., the EO/Li=10 blend diverged from this behavior, with a significant reduction in εₛ. In previously studied ionomers, this divergence from the Onsager fit at high temperatures was a result of ion aggregation that leads to a loss in the dielectric constant (see, e.g., Choi, U. H. et al. Macromolecules 2012, 45, 3974-3985). While the X-ray scattering of p5PhTFSI—Li did not suggest a structural transformation, the drop off of dᵢ above 90° C. (FIG. 4) correlated with the reduction in the dielectric constant at high temperatures.

In contrast to EO/Li=10, εₛ increased with temperature in the EO/Li=0, 2, and 5 blends. While uncommon in ionomers, this has been previously reported in polymerized ionic liquids (Stacy, E. W. et al. Macromolecules 2018, 51, 8637-8645).

This behavior was likely a result of the inverse Haven ratio, where more ions were contributing to conductivity at higher temperature, giving a larger relaxation strength associated with the rearrangement of ions. The inverse Haven ratio has been reported in polymers that exhibit interconnected aggregates, which is consistent with the percolated aggregates based on the collected X-ray scattering results (FIG. 3). A higher εₛ in EO/Li=5 than EO/Li=0 or 2 was likely due to aggregates swollen by PEO and thus greater ion rearrangement.

Interestingly, εₛ was slightly higher in EO/Li=0 than EO/Li=2, even though EO/Li=0 had no PEO and likely had a more tightly packed assembly. While εₛ was reduced with aggregation, the low dielectric constant of PEO may also have reduced the overall εₛ of EO/Li=2 relative to the neat p5PhTFSI—Li.

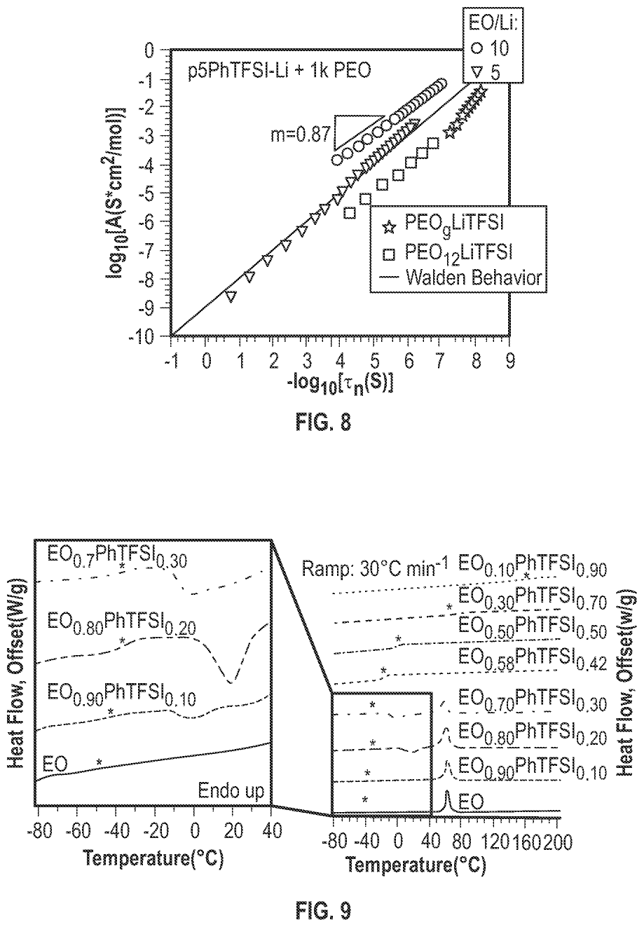

To gain further insight into the correlation between segmental relaxation and ion transport in EO/Li=5 and EO/Li=10, a Walden plot was constructed. This was a double logarithmic plot of the molar conductivity, Λ, versus the PEO relaxation time, τα, where ideal Walden behavior indicated strong coupling of ion transport to segmental motion, FIG. 8. The Walden behavior line was based on the ion conductivity of a dilute aqueous solution, with a slope of 1.

The EO/Li=5 blend exhibited Walden behavior similar to many other polymers and liquid electrolytes. However, EO/Li=10 fell approximately 1 order of magnitude above the Walden line. This, combined with a slope of less than 1, suggested superionic transport, in which ion mobility was at least partially decoupled from the polymer.

Such superionic behavior has been previously reported in some Li-salt polymer electrolytes, as well as single-anion conducting polymers in the glassy state (Fan, F. et al. Macromolecules 2015, 48, 4461-4470; Angell, C. A. et al. Nature 1993, 362, 137-139; Wang, Y. et al. Polymer (Guildf) 2014, 55, 4067-4076).

FIG. 8 was believed to be the first report of superionic transport in a single lithium ion conductor above the T_{g}. To better understand what was causing this superionic transport, it was important to identify the mechanisms involved with ion mobility. In systems containing a Li-salt and PEO-based polymers, the Li+ ions coordinate to the ether oxygens, and ion mobility is coupled to the segmental motion of the polymer backbone. However, in SICs, the Li+ ions will typically move with the covalently bound anion or hop between neighboring anionic groups. Blending p5PhTFSI—Li with PEO resulted in a competition between these transport mechanisms, and the resulting ion transport could vary depending on the amount of PEO, as evidenced by the “ideal” and “superionic” behavior in the EO/Li=5 and EO/Li=10 blends, respectively.

The superionic transport in the EO/Li=10 blend suggested there was at least some decoupling of the ion conductivity from PEO segmental motion. A possible reason for this may have been an increased ability of the Li+ ions to hop between TFSI⁻ anions due to PEO solvation.

In a recent study of PEO with LiTFSI salt, a much higher fraction of free Li+ ions was reported for EO/Li=10, compared to more negatively charged clusters with EO/Li=5 (see, e.g., Popovic, J., Macromol. Chem. Phys. 2021, 223, 2100344).

At modest amounts of PEO, the PEOTFSI complexes may have disrupted the ability for PEO to fully solvate the Li+, thus promoting the hopping mechanism. At higher levels of PEO, such as the p5PhTFSI—Li EO/Li=10 blend of this example, there appeared to be sufficient PEO to both fully solvate the Li+ ions and coordinate with the TFSI pendant groups.

Consequently, the Li+ transport could be decoupled from the PEO dynamics, because the energy barrier for hopping was reduced. While the decoupling of Li+ conductivity from the backbone mobility in the EO/Li=10 blend was promising, the balance between the TFSI⁻/Li+ and PEO/Li+ coordination strengths and the role of these interactions required further experiments and atomistic MD simulations.

Also compared in FIG. 8 was the molar conductivity of the p5PhTFSI—Li blends to that of LiTFSI salt in high-molecular weight PEO with similar PEO ratios: EO/Li=9 and PEO 5,000,000 g mol⁻¹ (Bandara, L. R. A. K. et al. Ionics 2000, 6, 239-247), EO/Li=12 and PEO 400,000 g mol⁻¹ (Das, S. et al. J. Appl. Phys. 2015, 117, 174103).

It should be noted that both of these systems were studied above their T_{g}, and the EO/Li=9 system was reported to be completely amorphous, while the EO/Li=12 system was semicrystalline (˜18% crystalline). Both PEO9LiTFSI and PEO12LiTFSI exhibited subionic behavior, where LiTFSI transport occurred even more slowly than segmental dynamics. The temperature ranges studied in PEO9LiTFSI and PEO12LiTFSI were much lower than in p5PhTFSI—Li EO/Li=10 because the dynamics of PEO in the PEO-LiTFSI electrolytes were significantly faster than in the single-ion conducting system of this example. For example, at 60° C., τ_{α}=8×10⁻⁹ s in PEO9LiTFSI, compared to 3.6×10⁻⁶ s in p5PhTFSI—Li EO/Li=10, a difference of nearly three orders of magnitude.

However, the difference in conductivity at 60° C. was only about 1 order of magnitude (9×10⁻⁵ S cm⁻¹ in PEO9LiTFSI and 5.5×10⁻⁶ S cm⁻¹ in p5PhTFSI—Li EO/Li=10). This was consistent with the significant improvement toward superionic behavior in the p5PhTFSI—Li EO/Li=10 blend. Note that a Li+ transference number of 1 was reported in the study in Example 2 of p5PhTFSI—Li with 20,000 g mol⁻¹ PEO. This result combined with the superionic transport described in this example for a p5PhTFSI—Li/PEO blend with 1000 g mol⁻¹ PEO indicated the potential of SICs to achieve decoupled transport and high conductivity. While ion solvation was accomplished with low-molecular-weight PEO here, alternative solvation strategies in conjunction with SICs are envisioned.

In this example, polymer electrolyte blends were created with varying quantities of a low-molecular-weight PEO with p5PhTFSI—Li, a precise SIC synthesized by a scalable ring-opening polymerization. A combination of experimental techniques was used to characterize the nanoscale morphology, ion transport, and segmental dynamics of these polymer electrolyte systems.

These p5PhTFSI—Li and PEO blends of this example were miscible in ratios up to at least EO/Li=10, and were fully amorphous. While the ions formed percolated assemblies that were nanophase separated from the backbone in neat p5PhTFSI—Li, the addition of PEO swelled these polar aggregates and introduced interactions between the ions (Li⁺ and TFSI⁻) and PEO. At EO/Li=5 and 10, the spacing between the TFSI⁻ anions was ˜6 Å, which could facilitate ion transport.

The addition of 1000 g mol⁻¹ PEO resulted in a significant increase in conductivity relative to the neat p5PhTFSI—Li (over 7 orders of magnitude at 130° C.). The EO/Li=10 blend had a conductivity of σ_{DC} of 3.8×10⁻⁵ S cm₋₁ at 90° C. and 1.8×10⁻⁴ S cm⁻¹ at 130° C., on par with other PEO-based single Li-ion conductors.

From a Walden plot analysis of the conductivity and PEO relaxation time, it was determined that the EO/Li=10 blend exhibited some decoupled ion transport at T>>T_{g}, which has not previously been reported in a single-Li ion conducting polymer melt. This behavior was likely a result of balancing the solvating action of PEO with both the covalently bound TFSI⁻ and Li⁺, such that the energy barrier for decoupled Li+ hopping was significantly reduced. These results suggested the value of solvating SICs to promote decoupled Li⁺ transport above the T_{g}.

### Example 2—Blends of Poly(Ethylene Oxide) and a Polyanion Comprising Precisely Spaced Delocalized Charges

In this example, a precision single-ion conductor with phenylsulfonyl(trifluoro-methylsulfonyl)imide lithium salt covalently bound to every fifth carbon of a polyethylene backbone, p5PhTFSI—Li, was synthesized via ring opening metathesis polymerization (ROMP) followed by post polymerization modification.

The conversion of poly(4-phenylcyclopentene), bearing 94% sulfonate anions, to trifluoromethanesulfonimide (TFSI) anions was highly efficient (˜90%) as determined by ¹⁹F NMR analysis and corroborated through other spectroscopic methods. The flexible hydrocarbon backbone combined with a bulky TFSI anion led to an observable glass transition temperature of 199° C. even at these high levels of ionization. A high thermal stability up to 375° C. was also observed.

Blending of p5PhTFSI—Li with poly(ethylene oxide) at various compositions was performed to investigate electrochemical performance and transference numbers with respect to the lithium electrode using a combination of impedance and polarization methods. At 90° C. and a 50:50 wt % blend composition, this system displayed the highest reported conductivity (2.00×10⁻⁴ S cm⁻¹) of a system with a demonstrated lithium-ion transference number near unity.

Such performance was surprising, because it is atypical of single ion conductors produced through post-polymerization modification, which may be attributed to the high yield of TFSI conversion. Investigations into the complex miscibility and phase behavior of these blends at various compositions was also probed by a combination of microscopy and differential scanning calorimetry, which is discussed in this example with reference to computational predictions of how charge correlations affect polymer blend phase behavior.

Synthesis of the precision SIC with phenylsulfonyl (trifluoromethylsulfonyl)-imide-Li pendants (p5PhTFSI—Li): For clarity in this example, the nomenclature used to describe the precise polyanion is p5PhX—Y, of which p5 stands for precise 5-carbon spacing, Ph stands for a phenyl group in direct connection to the backbone, and “X—Y” stands for type of chemistry on the para position of the phenyl group (e.g. sulfonic acid=S—H).

Synthesis of poly(4-phenylcyclopentene), followed by quantitative hydrogenation (p5Ph) and sulfonation (p5PhS—H) was performed in accordance with previous literature (see, e.g., W. J. Neary et al. Macromol. Rapid Commun., 2016, 37, 975-979; A. Kendrick, et al. Macromol. Rapid Commun., 2018, 39, 1800145).

The sulfonated polymer in the neutralized sodium form (p5PhS—Na) had a number average molar mass (Mₙ≈21.5 kg mol⁻¹) based on a degree of polymerization (Nₙ=89) determined by size exclusion chromatography of the parent p5Ph using conventional column calibration against PS standards. The degree of sulfonation (94%) was determined through titration.

The dispersity (Ð) of p5Ph was ˜1.6, and previous investigations revealed that the sulfonation procedure resulted in negligible degradation of the polymer. Following a modified procedure from the literature (see R. Meziane, et al. Electrochim. Acta, 2011, 57, 14-19), the p5PhS—Na was converted into the sulfonyl chloride derivative (p5PhS-Cl) through use of the Vilsmeier-Haack reagent produced from oxalyl chloride and a catalytic amount of dimethylformamide, as depicted in the following scheme:

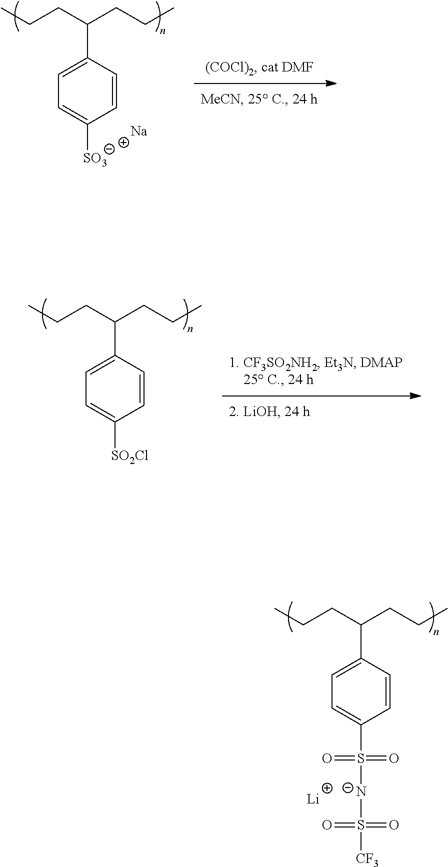

Due to its reactivity, the p5PhS-Cl was immediately converted to the lithium sulfonyl(trifluoromethylsulfonyl) imide derivative (p5PhTFSI—Li) through reaction with trifluoromethanesulfonamide. The resulting light brown polymer was collected (55.6% yield over both steps) and thoroughly dried under vacuum at 160° C. for 24 h prior to blending with PEO.

Preparation of polymer blends for differential scanning calorimetry (DSC): Blend compositions ranging from 90-10% (w/w) PEO (Mn=20 kg mol⁻¹, Sigma-Aldrich) with p5PhTFSI—Li were prepared. For each blend, ˜50 mg was obtained by dissolving measured amounts of p5PhTFSI—Li and PEO in a mixture of 80:20 volume ratio of acetonitrile (MeCN) and deionized water. The solutions were stirred for 24 h before being cast directly in aluminum DSC pans at 60° C. for 24 h on a temperature-controlled, level casting surface. The resulting sample filled DSC pans were dried in vacuo for 36 h at 160° C. and purged with Ar prior to hermetic sealing and characterization. Pure PEO was prepared as a control by employing the same method. All blend compositions were coded as EOxPhTFSIy in which EO represents PEO, PhTFSI represents p5PhTFSI—Li, and subscripts x and y represent the weight fraction of each component. The prepared blend compositions and cation to ethylene oxide molar ratios are shown in Table 1.

TABLE 1
DSC blend compositions

| | Weight fraction | Cation to oxygen molar |
|---|---|---|
| Sample^{a} | of PEO | ratio ([Li+]/[EO]) |
| PEO | 1 | 0 |
| EO_{0.90}PhTFSI_{0.10} | 0.9 | 0.013 |
| EO_{0.80}PhTFSI_{0.20} | 0.8 | 0.031 |
| EO_{0.70}PhTFSI_{0.30} | 0.7 | 0.051 |
| EO_{0.58}PhTFSI_{0.42} | 0.58 | 0.087 |
| EO_{0.50}PhTFSI_{0.50} | 0.5 | 0.13 |
| EO_{0.30}PhTFSI_{0.70} | 0.3 | 0.29 |
| EO_{0.10}PhTFSI_{0.90} | 0.1 | 1.1 |

^{a}For sample IDs EOxPhTFSIy, the subscripts x and y represent the weight fraction of that component.

Differential scanning calorimetry (DSC): Experiments were conducted with a TA Q2000 equipped with an RC900 intracooler and operated under dry nitrogen gas. To investigate glass transition temperature (T_{g}) of blend compositions, samples were heated from −90° C. to 215° C. at a rate of 30° C. min′ and cooled from 215° C. to −90° C. at a rate of 100° C. min′ three times. T_{g} was determined from the third heating scan. In order to investigate melting and crystallization behavior of blends, they were equilibrated at 100° C. to erase thermal history before being cooled to −90° C. and reheated to 100° C. at a rate of 10° C. min′. Melting and crystallization temperature of PEO was determined upon heating and cooling cycles, respectively.

Polarized optical microscopy: The preparation of samples for optical microscopy was conducted in a similar fashion to how samples were prepared for DSC. Pure PEO, EO_{0.90}PhTFSI_{0.10} and EO_{0.80}PhTFSI_{0.20} were cast on micro cover glasses from Ted Pella (22×22 mm) with the thickness between 0.16 and 0.19 mm. The samples were dried at 60° C. for 24 h and further dried under vacuum at 160° C. for another 36 h. Immediately prior to acquiring micrographs, samples were heated to 90° C. using a Linkam heating stage connected to a TMS94 temperature programmer and allowed to cooled to room temperature. Cooling was done passively by allowing the Linkam stage to reach room temperature which took approximately five minutes. Polarized optical micrographs were obtained using an Olympus BX51 optical microscope that was equipped with an Olympus type DP72 digital camera and analyzed using cellSens software.

Preparation of blends for ionic conductivity and transference number measurements: Polymer blends ranging in composition from pure PEO to 90 wt % p5PhTFSI—Li/10 wt % PEO were generated by combining calculated masses of PEO and p5PhTFSI—Li in borosilicate glass vials. Approximately 50 mg of each composition was measured. Each blend was then dissolved in approximately 250 μL of solution and stirred overnight at room temperature. Due to variations in blend solubility at varying composition, a two solvent system was employed and details are provided in the following table.

Electrochemical characterization blend
composition and casting environment

| | | Cation to | | |
|---|---|---|---|---|
| | Weight | oxygen | Solvent | |
| | fraction | molar ratio | MeCN:H₂O | Casting |
| Sample | of PEO | ([Li+]/[EO]) | (Volume Ratio) | Atmosphere |
| PEO | 1 | 0 | 1:0 | Argon |
| EO_{0.90}PhTFSI_{0.10} | 0.9 | 0.013 | 1:0 | Argon |
| EO_{0.80}PhTFSI_{0.20} | 0.8 | 0.031 | 1:0 | Argon |
| EO_{0.70}PhTFSI_{0.30} | 0.7 | 0.051 | 1:0 | Argon |
| EO_{0.58}PhTFSI_{0.42} | 0.58 | 0.087 | 80:20 | Air |
| EO_{0.50}PhTFSI_{0.50} | 0.5 | 0.13 | 80:20 | Air |
| EO_{0.30}PhTFSI_{0.70} | 0.3 | 0.29 | 80:20 | Air |
| EO_{0.10}PhTFSI_{0.90} | 0.1 | 1.1 | 80:20 | Air |

The first group included p5PhTFSI—Li rich blends (greater than 42 wt % p5PhTFSI—Li) that required a water co-solvent to facilitate the formation of a homogenous solution. As such, the aqueous group blends were dissolved in an 80:20 volume ratio of acetonitrile to water solvent.

Conversely, the nonaqueous group (less than 42 wt % p5PhTFSI—Li) was formed using pure acetonitrile as a solvent. Both groups were cast on glass slides at 60° C. for 48 h, with the aqueous group casted in an air atmosphere while the nonaqueous group was cast in an argon-filled glovebox. Each blend was then collected in glass vials prior to being purged with argon and dried in vacuo for 36 h at 160° C. After drying, each blend electrolyte was incorporated into lithium symmetric cells for electrochemical characterization. Cell construction was completed in an argon-filled glovebox with O₂ and H₂O levels below 0.1 and 0.4 ppm, respectively.

Electrolyte-filled Garolite spacer rings with ⅛ in. inner diameter were placed between lithium metal electrodes with diameter of 3/16 in. (MTI Corporation). Nickel tabs (TOB New Energy) were used as current collectors. Prior to cell assembly, the thickness of each electrolyte (160-420 μm) was measured for conductivity calculations. Each cell was vacuum sealed in laminated aluminum sheets (MTI Corporation) to avoid exposure to air during electrochemical characterization. Finally, each cell was annealed at 90° C. with small current densities of 0.02 mA cm⁻² being passed between electrodes to promote the formation of stable solid electrolyte interfaces for further testing. After this conditioning step, variation in the interfacial resistance of each unpolarized cell remained constant within ±2%.

Electrochemical impedance spectroscopy: The ionic conductivity of each blend composition was determined by measuring each lithium symmetric cell with electrochemical impedance spectroscopy (EIS). An alternating voltage with peak amplitude of 10 mV was applied in a frequency range of 1 MHz to 100 mHz. Cells were given 1 h to return to electrochemical equilibrium between measurements. The EIS measurements were conducted from 40 to 90° C., with three replicates per temperature per cell. At least two cells of each composition were constructed and measured. Thermal equilibration was performed for 3 h after each temperature change.

Transference number measurements: The cationic transference number was determined using the potentiostatic polarization method. Each cell was polarized using chronoamperometry at 10 mV for 1 h enabling the determination of the initial and steady state currents. The initial and steady state resistances were determined using EIS. At least three measurements were taken at 60 and 90° C., each.

A series of spectroscopic analyses was performed to confirm the successful synthesis and conversion of p5PhS—Na to p5PhTFSI—Li. Direct comparison of the ¹H NMR spectra in DMSO-d₆ reveals a downfield shift of the aryl protons from 7.48 and 6.96 ppm for p5PhS—Na to 7.63 and 7.11 ppm for p5PhTFSI—Li. This shift was attributed to the deshielding of these protons caused by the enhanced delocalization of the PhTFSI moiety. In addition, the ¹³C NMR spectrum of p5PhTFSI—Li revealed a unique quartet signal at 124-117 ppm which specifically arose from the splitting of the trifluoromethyl carbon nucleus with its three neighboring fluorine atoms.

With the installation of 3 equivalent fluorine atoms in the PhTFSI functionality, ¹⁹F NMR provided an opportunity to quantitatively evaluate conversion. The spectra presented a stacked comparison of the ¹⁹F NMR singlet signal of the CF₃SO₂NH₂ reagent used (−79.4 ppm) and p5PhTFSI—Li (−77.9 ppm). The polymer spectrum also confirmed successful purification and removal of any unreacted trifluoromethanesulfonamide. The distinct resolution of these two signals allowed CF₃SO₂NH₂ to be used as an internal standard, and a third ₁₉F NMR analysis was performed in DMSO-d₆ using a known mass of p5PhTFSI—Li spiked with a known mass of CF₃SO₂NH₂. Comparative integration of these signals allowed for determination of the approximate number of repeating units within the polymer bearing a PhTFSI functionality (˜84%).

Based on the 94% of repeating units that were originally sulfonated, this translated to ˜90% of the p5PhS—Na repeating units being successfully converted into the PhTFSI functionality. Attenuated total reflectance infrared (ATR-IR) spectroscopy was also employed to observe the difference between p5PhS—Li and p5PhTFSI—Li. It should be noted that p5PhS—Na was converted to p5PhS-Li by ion exchange for a more accurate vibrational absorption comparison (see, e.g., A. Kendrick, et al. Macromol. Rapid Commun., 2018, 39, 1800145). For the p5PhTFSI—Li, new strong signals at 1320 cm⁻¹ and 1280 cm⁻¹ appeared and corresponded to asymmetric stretching of OvSvO unique to the PhTFSI moiety that were not present in p5PhS-Li (see, e.g., A. Kendrick, et al. Macromol. Rapid Commun., 2018, 39, 1800145; K. Kim, et al. Front. Energy Res., 2020, 8, 240). In addition, the strong asymmetric stretch signal of C—F at 1190 cm⁻¹ indicated the presence of CF₃ (see, e.g., K. Kim, et al. Front. Energy Res., 2020, 8, 240; J. Min, et al. Proc. Natl. Acad. Sci. U.S.A., 2021, 118, e2107987118). Other vibrational modes of SO₂ in sulfonamides are also detected at 1160 and 1087 cm⁻¹ (see, e.g., R. Meziane, Electrochim. Acta, 2011, 57, 14-19; J. Min, Proc. Natl. Acad. Sci. U.S.A., 2021, 118, e2107987118). Finally, the symmetric S—N stretch and S—N—S vibrations were observed at 790 and 745 cm⁻¹, respectively.

For comparison, an overlay of the IR spectra of p5PhTFSI—Li and LiTFSI salt was prepared. While direct comparison of a crystalline solid salt to an amorphous polymer has some complications, the general peak profiles of both were in agreement. One exception was the CF₃ symmetric and asymmetric signals, which increased in intensity in the salt, as expected, due to the presence of two of these groups. Additionally, many of the signals in the LiTFSI salt were shifted to slightly higher wavenumber (higher energy), which could be attributed to its crystalline form, but also to the presence of an additional CF₃ group and its inductive effect on vibrational energies versus the phenyl group on one side of the polyanion.

Previous work has shown that when the LiTFSI salt is dissolved in an amorphous PEO matrix, many of the TFSI signals decrease in wavenumbers, consistent with what was observed (see, e.g., J. Min, et al. Proc. Natl. Acad. Sci. U.S.A., 2021, 118, e2107987118). With confidence in the successful synthesis of p5PhTFSI—Li, other physical and thermal properties were investigated. While p5PhS—Na was insoluble in MeCN, p5PhTFSI—Li dissolved in MeCN readily and maintained DMSO and aqueous solubility. The p5PhTFSI—Li also adopted a lighter brown color compared to the sulfonate version.

Thermogravimetric analysis (TGA) determined a 5% mass loss decomposition temperature (T_{d}) of 375° C. under argon. DSC revealed an observable glass transition temperature (T_{g}) of 199° C. Therefore p5PhTFSI—Li had higher thermal stability and a lower T_{g} than previously observed for p5PhS-Li, which was reported to have a T_{d} of 242° C. and no T_{g} observed up to 220° C. The reduction in T_{g} was rationalized by the larger and more delocalized PhTFSI anion (Q. Ma, et al. Angew. Chem., Int. Ed., 2016, 55, 2521-2525). When comparing this T_{g} to its polystyrene counterpart, PSTFSILi, early reports indicated a range between 150-160° C. at high levels of TFSI functionalization (see, e.g., R. Meziane, Electrochim. Acta, 2011, 57, 14-19; S. Inceoglu, et al. ACS Macro Lett., 2014, 3, 510-514). However, recent studies have shown that the T_{g} of PSTFSILi may be as high as 256° C. This discrepancy was possibly attributed to varying degrees of ionization and the drying process of PSTFSILi as incomplete removal of small molecules can plasticize and lead to a lower observed T_{g}. Here, it should be noted that a highly dry sample was prepared prior to DSC analysis as evidenced by the absence of a water or other solvent signals (with the exception of DMSO from the NMR solvent) in the 1H NMR spectrum. The effect of blending on thermal transitions of the polymers was investigated with DSC. It was challenging to observe the T_{g} of semicrystalline PEO due to the weak signal that resulted from the minority amorphous component.

Therefore, for T_{g} measurements of PEO and the blends, the sample was rapidly quenched from the amorphous state (cooling rate ˜100° C. min⁻¹) and then heated at a ramp rate of 30° C. min⁻¹. The suppression of crystallization due to rapid quenching and the moderate heating rate were sufficient to observe T_{g}, as shown at FIG. 9.

FIG. 9 depicts offset DSC thermograms of EOₓPhTFSI_{y} blends (ramp rate=30° C. min₋₁, 3rd heating, endo up). The black box zooms in on the DSC thermograms of pure PEO and blends with up to 30 wt % PhTFSI from −80° C. to 40° C. for better T_{g} observation. Asterisks represent midpoint T_{g} value of blends.

Although not always the case (vide infra), it is generally accepted that a miscible, binary polymer blend has a single, composition-dependent T_{g} observed by DSC. Meanwhile, more than one T_{g} was typically observed if blends were immiscible and the T_{g} values of each blend component were sufficiently different. As shown at FIG. 9, all blend compositions exhibited a single T_{g} between that of PEO (T_{g}=−48° C.) and p5PhTFSI—Li (T_{g}=199° C.). This suggested that PEO and p5PhTFSI—Li were miscible in the amorphous state.

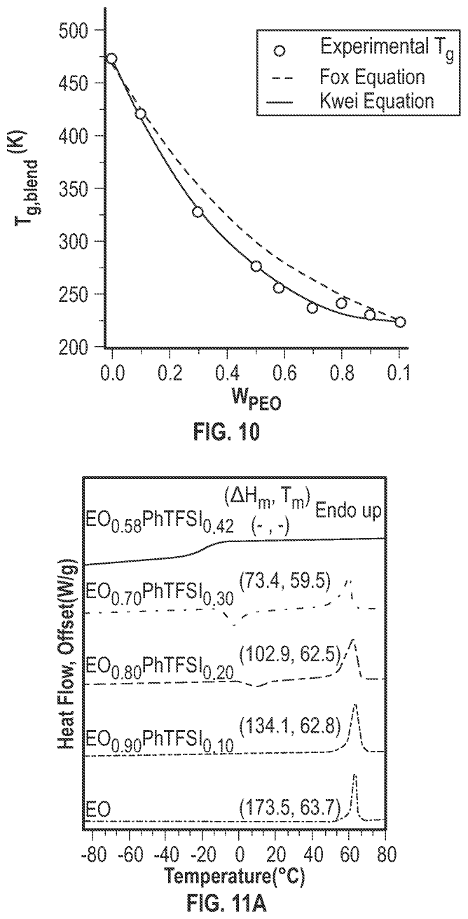

As shown at FIG. 10, the midpoint T_{g} values of each blend in FIG. 9 exhibited negative deviation from the classic Fox equation. FIG. 10 depicts the T_{g} of EOₓPhTFSI_{y} blends as a function of weight fraction of PEO, as well as fit of Kwei equation and hypothetical T_{g} from the Fox equation (dashed blue curve). For blended components that contained more complex interactions, the Kwei eqn (1) was used to account for these specific interactions (see T. K. Kwei et al., J. Polym. Sci., Polym. Lett. Ed., 1984, 22, 307-313):

$${T}_{g , blend} = \frac{{w}_{1} {T}_{g , 1} + k {w}_{2} {T}_{g , 2}}{{w}_{1} + {kw}_{2}} + {qw}_{1} {w}_{2} \qquad ( 1 )$$

wherein w₁ and W₂ are weight fractions of PEO and p5PhTFSI—Li, respectively. T_{g,1} and T_{g,2} represent pure PEO and p5PhTFSI—Li homopolymer components, respectively, while k and q are fitting parameters. The best fit of the Kwei equation to the experimental data (by minimization of squared error) is depicted at FIG. 10. The values of q and k were −108.3 and 0.462, respectively.

A small value of k and a negative value of q indicate that the intermolecular interactions between PEO and p5PhTFSI—Li were predominated by self-associated interactions, which increased free volume of the blends and caused negative deviation of blend T_{g} from the Fox equation.

DSC of the blends was also used to examine how the crystalline phase of PEO is affected by the addition of a diluent such as p5PhTFSI—Li. For this purpose, a slower ramp rate of 10° C. min⁻¹ was used.

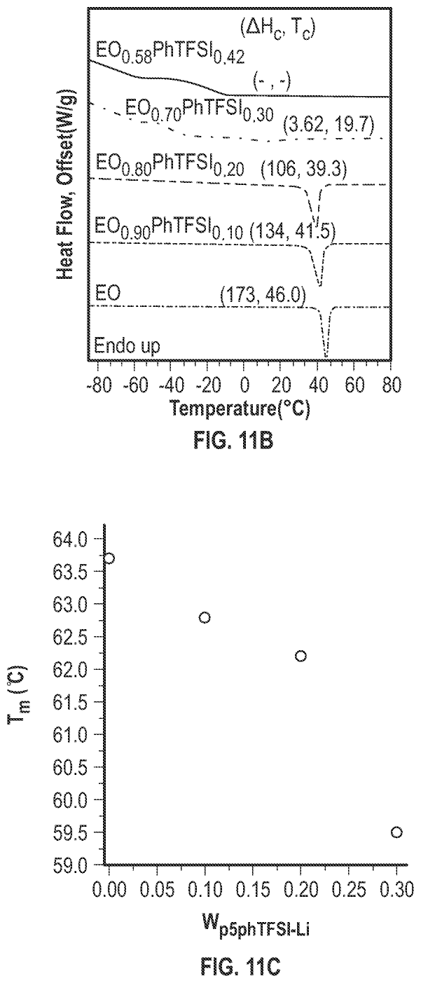

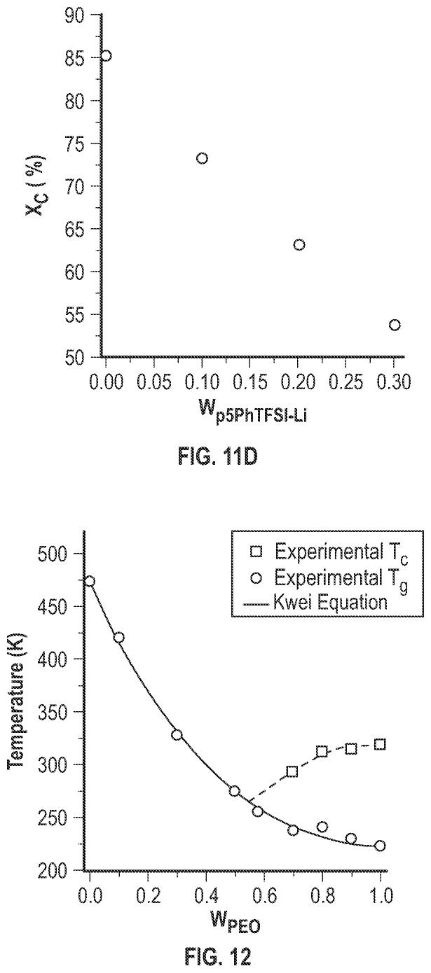

FIG. 11A depicts second heating DSC thermograms of blends of PEO with varying wt % of p5PhTFSI—Li up to 42 wt % (ramp rate=10° C. min₋₁, under N₂, endo up) and indicated values of ΔHₘ (J gₛₐₘₚₗₑ⁻¹) and Tₘ (° C.). FIG. 11B depicts cooling DSC thermograms of PEO after equilibrated at 100° C. with varying wt % of p5PhTFSI—Li up to 42 wt % (ramp rate=10° C. min⁻¹, under N₂, endo up) and indicated values of ΔH_{c} (J gₛₐₘₚₗₑ⁻¹) and T_{c} (° C.). FIG. 11C depicts the Tₘ of PEO as a function of p5PhTFSI—Li weight fraction. FIG. 11D depicts the degree of crystallinity per mass of PEO (Xc) as a function of p5PhTFSI—Li weight fraction. ΔHₘ values of different compositions were taken upon second heating with ramp rate of 10° C. min⁻¹ to calculate X_{c}.

As shown at FIG. 11A, endothermic melting peaks were observed in pure PEO (0 wt %) and blends up to 30 wt % of p5PhTFSI—Li. With increasing p5PhTFSI—Li content, the melting temperature (Tₘ) and the enthalpy of melting (ΔHₘ) decreased and disappeared at 42 wt %. When observing thermograms upon cooling at 10° C. min⁻¹, an exothermic PEO crystallization peak was apparent in blends up to 30 wt % of p5PhTFSI—Li (FIG. 11B). The lack of crystallization and melting peaks in blends of ≥42 wt % indicated that p5PhTFSI—Li interfered with the crystallization of PEO at these compositions. In blends with ≤30 wt % p5PhTFSI—Li, the Tₘ of PEO was depressed with increasing p5PhTFSI—Li content, as shown in FIG. 11C. This further corroborated the miscibility of the two polymers. Tₘ decreased from 63.7° C. for pure PEO to 62.8° C. at 10 wt % p5PhTFSI—Li and further decreased to 59.5° C. at 30 wt % p5PhTFSI—Li. The ΔHₘ values determined by DSC were used to determine the degree of PEO crystallinity in the blends according to eqn (2):

$${X}_{c} = \frac{Δ {H}_{m}}{f Δ {H}_{m}^{0}} \times 100 \qquad ( 2 )$$

in which X_{c} is the degree of crystallinity per mass of PEO, ΔHₘ⁰ is the standard melting enthalpy of 100% crystalline PEO, and f is the weight fraction of PEO in the blend. Due to a wide variety of reported values of ΔHₘ⁰ that ranged between 196 and 210 J g⁻¹, an average value of 203 J g⁻¹ was taken to calculate the degree of crystallinity in PEO (A. R. Polu, et al. J. Mater. Sci.: Mater. Electron., 2015, 26, 8548-8554; E. Salmon, et al. J. Appl. Polym. Sci., 1997, 65, 601-607; and G. Zardalidis, et al. Soft Matter, 2016, 12, 8124-8134).

The degree of crystallinity reduced from 85% for pure PEO to 73% for EO_{0.90}PhTFSI_{0.10} and further to 52% for EO_{0.70}PhTFSI_{0.30} (FIG. 11D). Blends containing 42 wt % p5PhTFSI—Li and above were amorphous. By observing blends of PEO with p5PhS-Li, it was found that PEO retained crystallinity regardless of p5PhS-Li content, which resulted in limited ionic conductivity at room temperature (K. Kim, et al. Macromol. Chem. Phys., 2021, 222, 2100269). The disruption of crystallinity in this system could most likely be attributed to the larger TFSI anion, which is known to suppress PEO crystallinity (L. Edman, et al. J. Mater. Res., 2011, 15, 1950-1954). Addition of LiTFSI salt to PEO was known to suppress crystallinity more significantly than other lithium salts, as well as reduce crystallization kinetics. Insight on the affect that various compositions of p5PhTFSI—Li has on the crystallization kinetics was extracted from the observation of cold crystallization exotherms seen upon heating blends above T_{g}. This behavior manifested when the cooling rate was too fast to allow complete crystallization to occur below Tₘ and prior to reaching the T_{g}.

Blends with 20 and 30 wt % p5PhTFSI—Li displayed cold crystallization exotherms in FIG. 9 and FIG. 11A. No cold crystallization was observed for pure PEO or the 10 wt % blend, which suggested that crystallization kinetics were slowed by the p5PhTFSI—Li at 20-30 wt % which could be attributed to the smaller window between T_{g} and the crystallization temperature (T_{c}) of these blends. A similar trend has been shown for PEO-containing, miscible polymer blends such as PEO/poly (benzyl methacrylate) or PEO/poly(vinylphenol-co-methyl methacrylate) which also exhibited the onset of cold crystallization at 20 or 30 wt % of the amorphous component (S. W. Kuo et al. Macromolecules, 2001, 34, 4089-4097; T. K. Mandal et al. J. Polym. Sci., Part B: Polym. Phys., 2000, 38, 562-572).

The T_{c} of PEO upon cooling decreased with increasing p5PhTFSI—Li content up to 30 wt % (FIG. 11B). Experimental T_{c} values were extrapolated to lower wPEO using a quadratic fit (FIG. 12), and the extrapolation intersects with the fitted Kwei equation at ˜55 wt % of PEO. At this intersection, the T_{g} of the polymer blend was equal to T_{c} of PEO and the crystallization of PEO was inhibited by slow segmental mobility of the miscible blend. Below 55 wt % of PEO, crystallization was completely suppressed due to chain rigidity (T_{c}<T_{g}) and this is consistent with our DSC observations.

FIG. 12 depicts the crystallization temperature, T_{c}, of PEO and glass transition temperature, T_{g}, of the blend as a function of PEO weight fraction, wPEO. The T_{c} curve was a quadratic fit to T_{c} and the extrapolation intersects the fit of the Kwei equation at the composition where crystallinity was completely absent (˜55 wt % PEO).

For blends containing ≥42 wt % p5PhTFSI—Li, water was used as a cosolvent (20% v/v) along with acetonitrile to fully solubilize these compositions for blend casting. To ensure the use of this cosolvent did not affect the thermal properties, additional DSC analysis was performed on samples of EO_{0.90} PhTFSI_{0.10} and EO_{0.70}PhTFSI_{0.30} that were cast identically in both pure acetonitrile and with 20% v/v water in acetonitrile. No significant differences in T_{g} or Tₘ and only slight differences in the cold crystallization peak shape were observed. This also corroborated that the drying protocols of this example (36 h in vacuo at 160° C.) for the blends were sufficient with or without water as a cosolvent.

Overall, the DSC results suggested that PEO and p5PhTFSI—Li formed a miscible blend. However, DSC alone has been shown inadequate for definitive conclusions of phase behavior. For example, it has been revealed that miscible polymer blends, such as PEO/poly(methyl nethacrylate), can exhibit two T_{g} values at midrange compositions (25-70%) owing to the Lodge-McLeish model and the large disparity of their homopolymer T_{g} values (T. P. Lodge, et al. J. Polym. Sci., Part B: Polym. Phys., 2006, 44, 756-763). Oppositely, two components with similar T_{g} values, yet a high χ parameter, would display only one transition in DSC even while strongly segregated (J. G. Kennemur et al. Macromolecules, 2012, 45, 7228-7236). The systems of this example presented a case where the blend components had very different T_{g} values yet showed only one transition even in midrange compositions. However, for polymer electrolyte blends, the addition of electrostatic interactions could complicate the miscibility behavior. In fact, computational studies of polyelectrolyte/polymer blends have revealed that ion correlations can enhance blend miscibility at all compositions when ion interactions are weak, but facilitate phase separation at low polyelectrolyte compositions when ion correlations are strong (see, e.g., C. E. Sing et al. ACS Macro Lett., 2014, 3, 698-702; C. E. Sing et al. J. Chem. Phys., 2015, 142, 034902; and C. E. Sing et al. ACS Macro Lett., 2013, 2, 1042-1046). Upon looking at the DSC traces of the systems of this example at low PhTFSI compositions, the weak T_{g} signals may not have rigorously justified miscibility. Moreover, the relatively poor agreement with the Kwei equation at these compositions prompted a closer examination. The local maximum in FIG. 12 at wPEO=0.8 should be noted.

Visual inspection of cast films of EO₉₀PhTFSI₁₀ and EO₈₀PhTFSI₂₀ revealed stark differences, with the former exhibiting visual macrophase separation of dark PhTFSI-rich regions within the mostly colorless EO-rich matrix. Conversely, EO₈₀PhTFSI₂₀ appeared homogenous and evenly colored.

Optical microscope images of pure PEO, EO_{0.90}PhTFSI_{0.10}, and EO_{0.80}PhTFSI_{0.20} were collected. The image of EO_{0.90}PhTFSI_{0.10} revealed regions that appeared rich in p5PhTFSI—Li or PEO, while optical microscopy of EO_{0.80}PhTFSI_{0.20} displayed a much more homogenous appearance expected of a miscible composition. Furthermore, the large spherulites of PEO crystals resembled those of pure PEO, while much smaller spherulites were observed in EO_{0.80}PhTFSI_{0.20}. Dark regions observed in the micrographs were likely voids within the films. These observations suggested that this system exhibited phase behavior of polyelectrolyte/polymer blends with strong ion correlation. In other words, the EO_{0.90}PhTFSI_{0.10} blend was expected to fall inside the binodal line for phase miscibility.

Therefore, it was hypothesized that strong ion correlation existed within the blends, and this was also corroborated by the data in FIG. 10, and the Kwei parameters used.

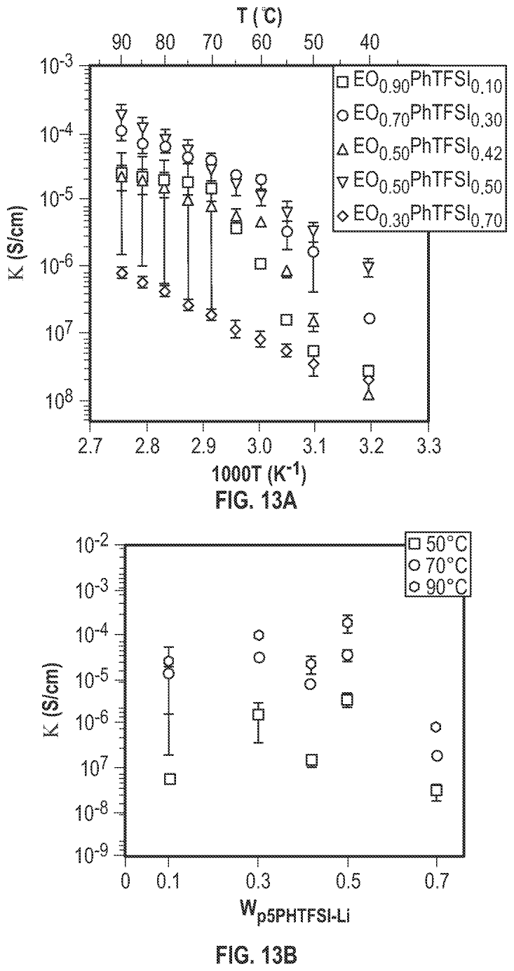

Electrochemical characterization: As FIG. 13A shows, ionic conductivities (κ) for PEO/p5PhTFSI—Li blends spanned a large range from 10⁻⁸ to 10⁻⁴ S cm⁻¹ over the temperatures and compositions investigated. Melting had a pronounced effect on conductivity in the semicrystalline blends. For EO_{0.90}PhTFSI_{0.10}, a significant increase in ionic conductivity was observed between 50° C. and 70° C.

Ionic conductivity (κ) of EOₓPhTFSI_{y} as a function of (FIG. 13A) temperature and (FIG. 13B) p5PhTFSI—Li weight fraction. Error bars represent one standard deviation of 3 measurements on at least 2 samples.

Referencing FIG. 11A, this increase in ionic conductivity coincided with the crystalline melting that began at 50° C. and completed at 70° C. Recognizing that ion conduction occurred primarily in the amorphous state, this increase in conductivity could be explained by the reduction of the crystalline phase, which increased the volume fraction of the conductive phase, reduced the tortuosity of conduction pathways, and increased segmental mobility (D. T. Hallinan et al. MRS Bull., 2018, 43, 759-767). Similar behavior has been observed in numerous other studies of transport in semicrystalline materials, including PEO-LiTFSI mixtures (M. Marzantowicz et al. Electrochim. Acta, 2005, 50, 3969-3977). In the crystalline phase of PEO, ion transport was limited as the chain conformations were static inside the crystalline regions (Z. Xue et al. J. Mater. Chem. A, 2015, 3, 19218-19253; D. Zhou et al. Polymer Electrolytes for Lithium-Based Batteries: Advances and Prospects, Chem, 2019, 5, 2326-2352). With increasing p5PhTFSI—Li content, the degree of crystallinity decreases (see FIG. 11D). This resulted in a smaller change in ionic conductivity with melting as p5PhTFSI—Li content was increased. At EO_{0.70}PhTFSI_{0.30}, the melting endotherm in FIG. 11A was broader, such that some melting had occurred even at the lowest temperature at which conductivity was measured (40° C.). Interestingly, DSC indicated that EO_{0.58}PhTFSI_{0.42} was fully amorphous (FIG. 11A) despite a large increase in conductivity observed between 40 and 70° C. at this composition. At a scan rate of 10° C. min⁻¹ observed by DSC, recrystallization kinetics were limited. As discussed in conjunction with FIG. 12, crystallization was slow due to T_{c} being only slightly above T_{g} at this composition. Rather than requiring seconds to minutes, crystallization likely required hours to days in EO_{0.58}PhTFSI_{0.42}. This phenomenon was observed in extended conductivity measurements at 40° C. over the course of days in EO_{0.58}TFSI_{0.42}, where the conductivity continued to decline over this period due to slow crystallization. EO_{0.58}TFSI_{0.42} values reported in FIG. 13A and FIG. 13B corresponded to initial measurements after the cells were allowed to cool from 60° C. to 40° C. over the course of 1 h. After this cooling period, subsequent isothermal measurements were taken every hour. The conductivity of the blend decreased with each of these subsequent measurements, which suggested slow isothermal crystallization was occurring.

Due to conductivity data being collected on heating and samples spending hours at each temperature, more time was available for an equilibrium degree of crystallinity to be achieved in EO_{0.58}PhTFSI_{0.42}, which resulted in the melting signature being present in the conductivity data of FIG. 13A. This was another example of how Li transport was sensitive to polymer structure, which could be another measure to detect crystallization (M. Minelli et al. J. Membr. Sci., 2013, 432, 83-89).

It should be noted that EO_{0.58}PhTFSI_{0.42} was the only composition that showed this sensitivity to the heating protocol while all other compositions showed stable conductivities regardless of thermal history. The truly amorphous blends, in which T_{c}<T_{g} (EO_{0.5}PhTFSI_{0.5} and EO_{0.3}PhTFSI_{0.70}), exhibited a single activation energy across the entire temperature range from 40° C. to 90° C. In other words, it appeared that if enough polyanion was added to entirely inhibit PEO crystallization, no step change was observed. This likely explained the lack of a drastic change in conductivity for the blends with p5PhTFSI—Li weight percentages greater than 42%.

The larger error bars produced from triplicate conductivity measurements on two samples of EO_{0.90}PhTFSI_{0.10} in FIG. 13A and FIG. 13B supported the observation and conclusion of phase separation at this composition. Based on the colors of the pure components (PEO white and p5PhTFSI—Li light brown), visual inspection of the optical images indicated that there were phase regions more concentrated in each blend component for EO_{0.90}PhTFSI_{0.10}. Furthermore, the optical image of EO_{0.80}PhTFSI_{0.20} appeared miscible based on color uniformity. Therefore, the thermodynamic phase boundary occurred between 10 and 20 wt % p5PhTFSI—Li.

The macroscopic phase separation below this critical polyanion composition caused non-uniform ion distribution and large variance in conductivity, as seen in FIG. 13A and FIG. 13B. At p5PhTFSI—Li>20 wt %, the error bars for conductivity were consistently smaller, which also supported the conclusion that these were miscible blends. The conductivity data at three temperatures is presented again in FIG. 13B as a function of p5PhTFSI—Li weight fraction to observe the effect of blend composition on ionic conductivity. Focusing on the data at 90° C., where there was no complexity due to different degrees of crystallinity, it was clear that the blends with 30 to 50% p5PhTFSI—Li had the highest ionic conductivity, with the 50-50 blend being the best performing with an ionic conductivity of 2.00×10⁻⁴ S cm⁻¹. As reported in Table 1, these weight fractions corresponded to Li+: 0 mole ratios between 0.05 and 0.13, which were the compositions at which PEO-LiTFSI (polymer-salt) mixtures had optimal ionic conductivity as well, with a value of 2×10⁻³ S cm⁻¹ (D. M. Pesko et al. J. Electrochem. Soc., 2018, 165, A3186-A3194; A. A. Teran et al. Solid State Ionics, 2011, 203, 18-21). The root cause of the local minimum in ionic conductivity at 42% p5PhTFSI—Li was unknown.

However, in the case of PEO/LiTFSI binary electrolytes, complex nonmonotonic relationships between salt concentration and transport parameters have been observed (W. Gorecki et al. J. Phys.: Condens. Matter, 1995, 7, 6823-6832; K. Pożyczka et al. Electrochim. Acta, 2017, 227, 127-135; and P. Georeń et al. Electrochim. Acta, 2001, 47, 577-587).

Such complex behavior has been attributed to competition between polymer segmental mobility, ion concentration, dissociation state, and interactions among components (ions and polymer). Specifically, polymer mobility, as represented by the segmental relaxation time, decreases monotonically with increasing salt concentration. This may be attributed to attractive associations between ether oxygens and lithium cations. Conversely, as more salt is added, more charge is available for conduction enabling higher overall conductivity. Moreover, the number of free, dissociated ions decreases above a limiting salt concentration, resulting in non-conductive neutral ion pairs and less mobile charged ion clusters. Considering that the cation and polysolvent are chemically identical to the binary PEO/LiTFSI electrolyte, the nonmonotonic behavior in FIG. 13B could have been due to similar effects.

In order to quantify the differing slopes apparent at high temperature in FIG. 13A, the conductivity data between 70 and 90° C. was fit with the Arrhenius and Vogel-Fulcher-Tammann (VFT) models. Due to the rather narrow temperature range over which fits could be applied and the similar goodness of fit of the VFT and Arrhenius models, the activation energy from the Arrhenius fits were examined more closely. There was an apparent maximum in activation energy at the 50-50 blend, which exhibited the highest conductivity, followed by an apparent decrease in activation energy with increasing PEO content, from which might be inferred that PEO solvation facilitates ion mobility. However, the error bars of one standard deviation could lead one to conclude that nothing quantitative could be concluded regarding the slope of conductivity in the fully amorphous samples. The findings of this study revealed that PEO/p5PhTFSI—Li was competitive with state-of-the-art polymer-based SICs.

For example, PEO/lithium poly[(4-styrenesulfonyl)(fluorosulfonyl)imide] (LiPSFSI) displayed a maximum conductivity of 5.3×10⁻⁵ S cm⁻¹ at 90° C., while PEO/PSTFSILi's maximum conductivity was 10⁻⁵ S cm⁻¹ at 90° C. (Q. Ma, RSC Adv., 2016, 6, 32454-32461; R. Meziane et al. Electrochim. Acta, 2011, 57, 14-19). It should also be noted that PEO/p5PhTFSI—Li may have showed high conductivity due to the efficiency of the post-polymerization modification, which suggested that polymerization of a charged monomer was not always needed to achieve high ionic functionalization.

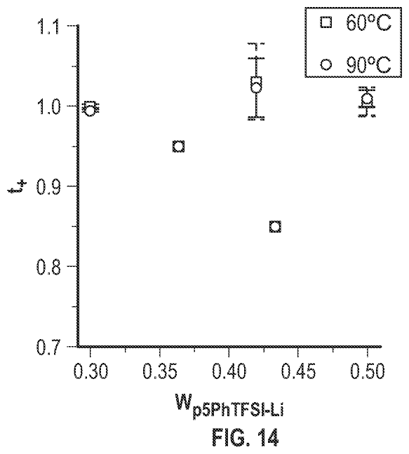

FIG. 14 depicts the cation transference number (t+) of 30, 42, and 50 wt % p5PhTFSI—Li blends at 60° C. and 90° C. Error bars represent 1 standard deviation of at least 3 measurements on at least 2 samples.

As shown at FIG. 14, transference numbers for the tested blends were all unity within experimental uncertainty. A t+ value greater than one was possible, indicating that cations were migrating toward the cathode, as expected, and that some anions were also migrating toward the cathode (in the opposite direction to that expected based on their charge). This likely indicated that the flow of Li ions, due to the applied electric field, was pulling polyanion chains along with them by electroneutrality. However, all error bars included unity indicating that these blends were, most probably, near perfect single-ion conductors. Limitations of the potentiostatic polarization method are numerous and should be acknowledged. The potentiostatic polarization method relies upon the assumption of dilute electrolytes and agreement between this method and more rigorous methods, like galvanostatic polarization and the Newman method declines in concentrated electrolytes (D. M. Pesko, et al. J. Electrochem. Soc., 2018, 165, A3014-A3021; D. M. Pesko et al. J. Electrochem. Soc., 2017, 164, E3569-E3575; S. Zugmann et al. Electrochim. Acta, 2011, 56, 3926-3933).

Ion specific measurements, such as pulsed field gradient-nuclear magnetic resonance (PFG-NMR), could elucidate the physical cause of cation transference numbers greater than one, if in fact that was the case in these blends. The transference number values of PEO/p5PhTFSI—Li were the highest measured for a polymerbased SIC. For instance, the previously mentioned PEO/LiPSFSI and PEO/PSTFSILi showed maximum transference numbers of 0.9 and 0.92 respectively. Because the limiting current of an electrolyte is tied not only to ionic conductivity, but also to transference number, a transference number of one and conductivity of 2.00×10⁻⁴ cm⁻¹ likely meant that these blends were likely to exhibit battery cycling rates that are competitive with PEO/LiTFSI electrolytes (M. P. Blatt et al. Ind. Eng. Chem. Res., 2021, 60, 17303-17327).

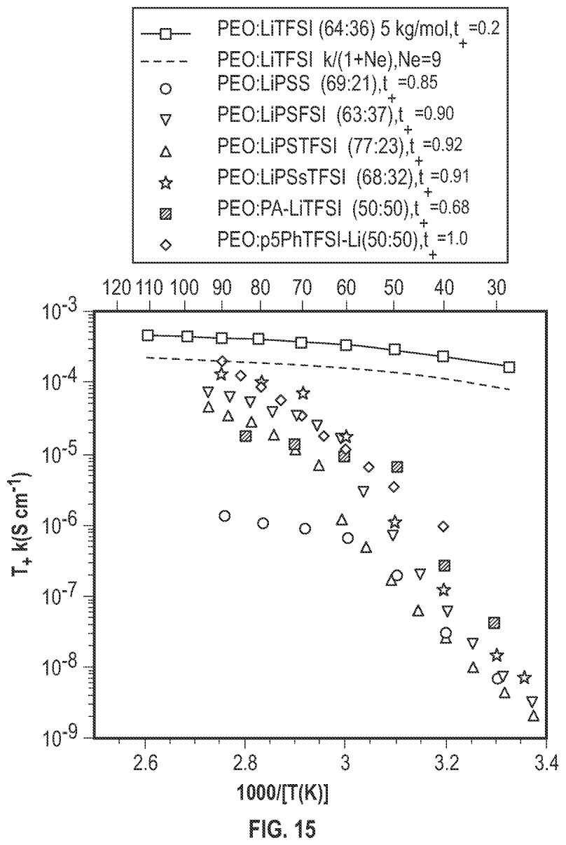

In electrochemical cells such as batteries, conduction of only one ion is usually desired. This is the case in lithium-ion and lithium-metal batteries in which flux of lithium ions is the only flux that results in useful current. The ability of an electrolyte to conduct the ion of interest was conveniently estimated as the product of the transference number of that ion and the overall ionic conductivity of the electrolyte. In FIG. 15, this metric was used to compare the embodiments of this example with several polymer blend electrolytes whose transference number and conductivity have been reported.

FIG. 15 depicts Arrhenius plots of lithium-ion conductivity, approximated as product of cation transference number and conductivity. Polymer blend electrolytes from this example (filled diamonds) and the literature (open symbols)(M. P. Blatt et al. Ind. Eng. Chem. Res., 2021, 60, 17303-17327) are shown with polymer electrolyte reference, PEO/LiTFSI salt (curve through squares). Also shown is the more rigorous reference values of the polymer electrolyte reference that accounted for thermodynamic non-ideality via the Newman number, Ne. Mass fractions of blends and mixtures are shown in the legend. As shown in the legend, the PEO reference had a low molar mass, 5 kg mol-¹. Both conductivity and cation transference number have been reported for PEO blended with the following polyanions: LiPSS=lithium poly(4-styrene sulfonate), LiPSFSI=lithium poly[(4-styrenesulfonyl) (fluorosulfonyl)imide], LiPSTFSI=lithium poly[(4-styrenesulfonyl) (trifluoromethanesulfonyl)imide], LiPSsTFSI=poly[(4-styrenesulfonyl)(trifluorometh-yl(S-trifluoromethylsulfonylimino) sulfonyl)imide], PA-LiTFSI=lithium poly[(trifluoromethyl) sulfonyl acrylamide].

Shown in FIG. 15 is the canonical PEO/LiTFSI salt reference. A more rigorous prediction of limiting current of an electrolyte than t+κ could be determined using the dimensionless Newman number, Ne, as follows: κ/(1+Ne). This accounted for thermodynamic non-ideality and has been determined in the literature (D. M. Pesko et al. Macromolecules, 2016, 49, 5244-5255). This more rigorous reference was also shown in FIG. 15. The t+K value of the 50:50 blend in this example reached the rigorous metric at 90° C. Perhaps more interesting was the fact that the 50:50 blend in this example surpassed all other blend electrolytes at 40° C. This appeared to be due to the lack of a step change below 70° C. that occurred in the other blends because of PEO crystallization. The serendipitous depression of T_{c} to below T_{g}, which also remained below room temperature, appeared to be an alternative approach to boost near-ambient polymer electrolyte conductivity. Other approaches that have achieved similar performance at and near room temperature included crosslinking PEO or incorporating PEO into a random or block copolymer (H. Zhang et al. Chem. Soc. Rev., 2017, 46, 797-815). Although the improvement over existing reports was modest, this example produced a post-polymerization modified polyelectrolyte blend that is able to compete with the state-of-the-art in single-ion conducting solid electrolytes. Moreover, the embodiments of this example had a truly unity transference number.

In this example, a novel polyanion, p5PhTFSI—Li was blended with PEO whereupon a maximum ionic conductivity of 2.00×10⁻⁴ S cm⁻¹ was measured at 90° C. for 50:50 wt % composition. These blends showed remarkable transference numbers near unity in combination with one of the highest ionic conductivities of a polymer blend electrolyte reported to date, even though the delocalized charges were spaced farther apart than in its PS counterpart. Visual inspection, optical microscopy, and DSC studies indicated that the blends were miscible at most p5PhTFSI—Li compositions. In addition to conductivity measurements, they also collectively indicated phase coexistence at 10 wt % p5PhTFSI—Li, which was theoretically predicted for polymer blends with strongly correlated ions.

The results herein demonstrated that continued fundamental studies on new synthetic materials, in combination with modular synthetic approaches (post polymerization modification) and formulation (blending), could be used to generate polymer electrolytes that are competitive with the state of the art. The ease of synthesis and high ionic conductivity combined with innate benefits of SICs (dendrite suppression, rate capability, and energy efficiency) make p5PhTFSI—Li a promising polyanion.

That which is claimed is:

1. A composition comprising:
a polymer blend comprising a polysolvent and a polymer, the polymer comprising a repeat unit according to formula (A);
wherein a weight ratio of the polysolvent to the polymer in the polymer blend is about 10:90 to about 90:10; 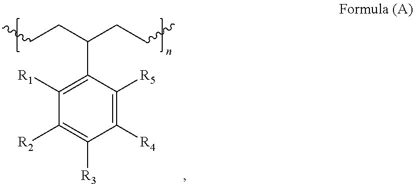
wherein R₁-R₅ are independently selected from the group consisting of hydrogen, a substituent of formula (a), and a monovalent C₁-C₁₀ hydrocarbyl;
wherein at least one of R₁-R₅ is the substituent of formula (a); 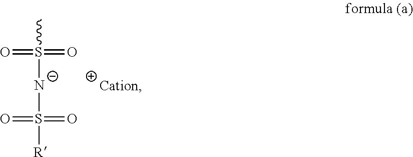
wherein R′ is a halogenated C₁-C₅ hydrocarbyl; and
wherein n is 1 to 10,000.

2. The composition of claim 1, wherein the polymer blend is a miscible polymer blend.

3. The composition of claim 1, wherein R₃ is the substituent of formula (a), and R₁, R₂, R₄, and R₅ are hydrogen.

4. The composition of claim 1, wherein R′ is a perhalogenated C₁-C₅ hydrocarbyl.

5. The composition of claim 1, wherein R′ is a trifluoromethyl, and the substituent of formula (a) has the following structure:

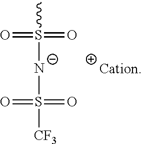

6. The composition of claim 1, wherein the polymer comprises repeat units according to formula (B): 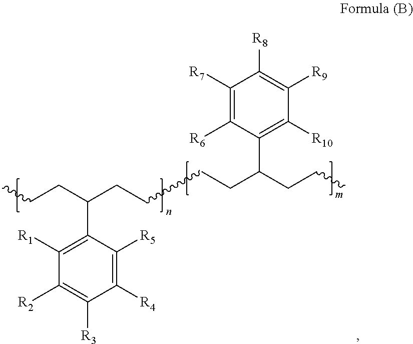
wherein R₁-R₁₀ are independently selected from the group consisting of hydrogen, a substituent of formula (a), a substituent of formula (b), and a monovalent C₁-C₁₀ hydrocarbyl; 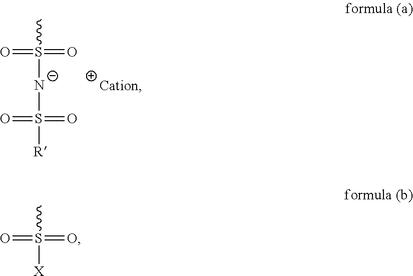
wherein R′ is a halogenated C₁-C₅ hydrocarbyl, and X is a halogen;
wherein at least one of R₁-R₅ is the substituent of formula (a), and
wherein n and m independently are 1 to 10,000.

7. The composition of claim 1, wherein the polymer has a degree of substitution of the substituent of formula (a) of about 1% to about 125%.

8. The composition of claim 1, wherein the polymer has a degree of substitution of the substituent of formula (a) of about 80% to about 120%.

9. The composition of claim 1, wherein the polymer is at least partially cross-linked.

10. The composition of claim 1, wherein the weight ratio of the polysolvent to the polymer is about 40:60 to about 60:40.

11. The composition of claim 1, wherein the cation of the substituent of formula (a) comprises lithium.

12. The composition of claim 1, wherein the polymer is a homopolymer.

13. The composition of claim 1, wherein the polysolvent has a glass transition temperature (T_{g}) of −40° C. or less.

14. The composition of claim 1, wherein the polysolvent comprises a poly(alkylene oxide).

15. The composition of claim 1, wherein the polysolvent has a number average molecular weight (Mₙ) of about 1,000 g/mol to about 30,000 g/mol.

16. The composition of claim 1, wherein the polysolvent has a number average molecular weight (Mₙ) of about 500 g/mol to about 2,000 g/mol.

17. The composition of claim 1, wherein the polymer blend is in the form of a film.

18. A device comprising the composition of claim 17, wherein the device is a lithium-ion battery.

19. The device of claim 18, wherein the lithium-ion battery further comprises:
a first current collector;
an anode;
a cathode; and
a second current collector;
wherein the composition is arranged between the anode and the cathode;
wherein the anode is arranged between the composition and the first current collector; and
wherein the cathode is arranged between the composition and the second current collector.

20. A method of forming a composition, the method comprising:
dissolving a polysolvent and a polymer comprising a repeat unit according to formula (A) in a solvent to form a mixture; and
removing at least a portion of the solvent to form a polymer blend;
wherein a weight ratio of the polysolvent to the polymer comprising the repeat unit according to formula (A) in the solvent is about 10:90 to about 90:10; 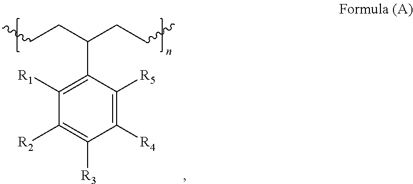
wherein R₁-R₅ are independently selected from the group consisting of hydrogen, a substituent of formula (a), and a monovalent C₁-C₁₀ hydrocarbyl;
wherein at least one of R₁-R₅ is the substituent of formula (a); 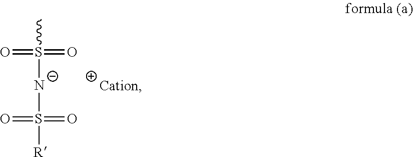
wherein R′ is a halogenated C₁-C₅ hydrocarbyl; and
wherein n is 1 to 10,000.
